(19) United States
(12) Patent Application Publication
(10) Pub. No.: US 2019/0363584 A1
(43) Pub. Date: Nov. 28, 2019

(54) MULTI-MODE ANTENNA AND WIRELESS POWER RECEPTION DEVICE USING SAME

(71) Applicant: LG INNOTEK CO., LTD., Seoul (KR)

(72) Inventor: Sung Hyun LEEM, Seoul (KR)

(73) Assignee: LG INNOTEK CO., LTD., Seoul (KR)

(21) Appl. No.: 16/347,964

(22) PCT Filed: Sep. 26, 2017
(86) PCT No.: PCT/KR2017/010608

§ 371 Date: May 7, 2019

(30) Foreign Application Priority Data
Nov. 15, 2016 (KR) 10-2016-0151815
Nov. 23, 2016 (KR) 10-2016-0156426
Dec. 6, 2016 (KR) 10-2016-0164972

(51) Int. Cl. H02J 50/20; H02J 7/02; H02J 50/80; H01Q 1/38; H01Q 5/30; H01Q 7/00; H01Q 13/00; H04B 5/00; H01Q 1/52

(52) U.S. Cl. CPC H02J 50/20; H02J 7/025; H02J 50/80; H01Q 1/38; H01Q 1/248; H01Q 7/00; H01Q 13/00; H04B 5/0075; H01Q 1/521; H01Q 5/30

(57) ABSTRACT

The present invention relates to a multi-mode antenna and a wireless power reception device having the same mounted thereon. A multi-mode antenna module according to an embodiment of the present invention comprises: a printed circuit board; a first antenna, disposed by pattern printing in a central area of the printed circuit board, for wireless charging; a second antenna, disposed by pattern printing on the outer periphery of the first antenna, for first near-field wireless communication; a third antenna disposed by pattern printing on the outer periphery of the second antenna such that the third antenna does not overlap the second antenna for second near-field wireless communication; a first connection terminal for connecting both ends of a first connection pattern corresponding to the first antenna; and a second connection terminal for connecting both ends of each of a second and a third connection pattern corresponding to the second antenna and the third antenna, respectively, wherein the first connection terminal and the second connection terminal may be arranged to be separated from each other on the printed circuit board.

### TECHNICAL FIELD

Embodiments relate to wireless charging technology, and more particularly, to a multi-mode antenna for wireless charging and short-distance wireless communication and a wireless power reception device including the multi-mode antenna installed therein.

### BACKGROUND ART

Wireless power transmission or wireless energy transfer technology refers to technology of wirelessly transmitting electric energy from a transmitter to a receiver using the principle of magnetic induction. In the 1800s, electrical motors or transformers using the principle of electromagnetic induction already started to be used and then a method of radiating radio waves or electromagnetic waves such as lasers and transmitting electric energy were also attempted. Commonly used electric toothbrushes or electric razors are charged using the principle of electromagnetic induction.

Up to now, a wireless energy transfer method may be roughly divided into a magnetic induction method, an electromagnetic resonance method and a power transmission method using a short-wavelength radio frequency.

The magnetic induction method refers to technology of using a phenomenon that, when two coils are adjacently placed and current is supplied to one coil, a magnetic flux is generated to generate electromotive force in the other coil, and is commercially available in small apparatuses such as mobile phones. The magnetic induction method may transmit power of a maximum of several kilowatts (kW) and has high efficiency. However, since a maximum transmission distance is 1 cm or less, an apparatus should be generally located to be adjacent to a charger.

The magnetic induction method uses an electric field or a magnetic field instead of electromagnetic waves or current. The magnetic induction method is hardly influenced by an electromagnetic wave and thus is harmless to other electronic apparatuses and humans. In contrast, the magnetic induction method may be used at a limited distance and in a limited space and energy transfer efficiency is slightly low.

The short-wavelength wireless power transmission method—briefly referred to as an RF method—uses a method of directly transmitting and receiving energy in the form of radio waves. This technology is an RF type wireless power transmission method using a rectenna. Rectenna means is a compound word of “antenna” and “rectifier” and means an element for directly converting RF power into direct current (DC) power. That is, the RF method is technology of converting AC radio waves into DC radio waves and using DC radio waves and, recently, research into commercialization thereof has been actively conducted as efficiency is improved.

Wireless power transmission technology may be variously used in IT, railroad and consumer-electronics in addition to the mobile industry.

In general, a wireless power transmission apparatus includes a coil for wireless power transmission, hereinafter referred to as a transmission coil, and a wireless power reception apparatus includes an antenna for wireless power reception, hereinafter, referred to as a reception coil.

Recently, electronic devices with short-distance wireless communication and wireless charging functions installed therein have been released and, thus, research has been actively conducted into an integrated antenna module.

In this regard, Korean Patent Publication No. 10-2015-0028042 “Multi-mode Wireless Power Reception Device and Wireless Power Reception Method thereof” discloses a wireless power receiver for enabling NFC communication and multi-mode wireless charging.

However, a conventional antenna of a multi-mode wireless power reception device does not consider an interference phenomenon between antennas and, thus, there is a problem in terms of degraded wireless charging efficiency and recognition performance of short-distance wireless communication.

A portable terminal such as a cellular phone and a laptop computer includes a battery for storing power and a circuit for charging and discharging the battery. To charge the battery of such a terminal, the terminal needs to receive power from an external charger.

In general, an example of an electrical connection mode between a battery and a charging device for charging the battery with power includes a terminal supply mode of receiving commercial power, converting the commercial power into voltage and current corresponding to the battery, and supplying electrical energy to the battery through a terminal of the corresponding battery. The terminal supply mode is accompanied by use of a physical cable or wiring. Accordingly, when many equipments of the terminal supply mode are used, a significant working space is occupied by many cables, it is difficult to organize the cables, and an outer appearance is achieved. In addition, the terminal supply mode causes problems such as an instantaneous discharge phenomenon due to different potential differences between terminals, damage and fire due to impurities, natural discharge, and degradation in lifespan and performance of a battery.

Recently, to overcome the problems, a charging system (hereinafter, referred to as a “wireless charging system”) and control methods using a mode of wirelessly transmitting power have been proposed. In the past, a wireless charging system is not basically installed in some terminals and a consumer needs to purchase a separate accessory of a wireless charging receiver and, thus, a demand for a wireless charging system is low, but users of wireless charging are expected to be remarkably increased and, in the future, a terminal manufacturer is also expected to basically install a wireless charging function.

In general, a wireless charging system includes a wireless power transmitter that supplies energy electrical energy in a wireless power transmission mode and a wireless power receiver that receives electrical energy supplied from the wireless power transmitter and charges a battery with the electrical energy.

The wireless charging system may transmit power in at least one wireless power transmission mode (e.g., an electromagnetic induction mode, an electromagnetic resonance mode, and a radio frequency (RF) wireless power transmission mode).

For example, the wireless power transmission mode may use various wireless power transmission standards based on an electromagnetic induction mode for performing charging using an electromagnetic induction principle whereby a power transmission end coil generates a magnetic field to induce electricity in a reception end coil by the influence of the magnetic field. Here, the wireless power transmission standard of the electromagnetic induction mode may include a wireless charging technology of an electromagnetic induction mode in the wireless power consortium (WPC) and/or the power matters alliance (PMA).

As another example, the wireless power transmission mode may use an electromagnetic resonance mode for transmitting power to a wireless power receiver positioned at a short distance via synchronization between a magnetic field generated by a transmission coil of a wireless power transmitter and a specific resonance frequency. Here, the electromagnetic resonance mode may include a wireless charging technology defined in the alliance for the wireless power (A4WP) standard institute that is a wireless charging technology standard institute.

As another example, the wireless power transmission mode may use an RF wireless power transmission mode for transmitting power to a wireless power receiver positioned at a long distance by delivering low power energy in an RF signal.

A terminal may include a payment system based on fintech as well as a wireless charging system. For example, the terminal may include a payment system such as magnetic secure transmission (MST) or near field communication (NFC). Accordingly, the terminal may include an antenna for a wireless charging system and any antenna for various types of payment systems.

An antenna for a wireless charging system and a plurality of antennas for various types of payment systems may have respective regulated wireless communication standards, but there is a problem in that interference occurs between wireless communication signals with different physical characteristics.

In addition, there is a spatial limit in that one terminal is disposed in an environment in which various antennas need to be installed, and it is required to differentiate between respective operations of a wireless charging system and various types of payment systems.

Accordingly, there is a need for a detailed method of reducing a burden of installing a plurality of antennas installed in one terminal and differentiating between operations.

### DISCLOSURE

### Technical Problem

Embodiments provide a multi-mode antenna and a wireless power reception device using the same.

Embodiments provide a multi-mode antenna module and a wireless reception device including the corresponding multi-mode antenna module installed therein, for minimizing an interference phenomenon between antennas to maximize wireless charging efficiency and recognition performance.

Embodiments provide a multi-mode antenna module and a wireless reception device including the corresponding multi-mode antenna module installed therein, for reducing resistance of a coil of an antenna to enhance recognition sensitivity and performance.

Embodiments provide a method and apparatus for controlling a wireless power receiver including an antenna for combined use of magnetic security transmission (MST) and wireless power transmission (WPT).

Embodiments also provide a detailed method and apparatus for overcoming a difficulty in disposing a plurality of antennas including an antenna for combined use for simultaneously performing an operation for a wireless charging system and an operation for a payment system based on fintech by one antenna and for differentiating operations of various systems using the antenna for combined use.

Objects of the embodiments are not limited to the above objects and features of the embodiments will be set forth in part in the description which follows and in part will become apparent to those having ordinary skill in the art upon examination of the following or may be learned from practice of the embodiments.

### Technical Solution

Embodiments may provide a multi-mode antenna and a wireless power reception device including the multi-mode antenna installed therein.

In one embodiment, a multi-mode antenna module includes a printed circuit board, a first antenna that is pattern-printed and disposed in a central region of the printed circuit board for wireless charging, a second antenna that is pattern-printed and disposed outside the first antenna for first short-distance wireless communication, a third antenna that is pattern-printed and disposed outside the second antenna not to overlap the second antenna for second short-distance wireless communication, a first connection terminal for connection of opposite ends of a first connection pattern corresponding to the first antenna, and a second connection terminal for connection of opposite ends of second and third connection patterns corresponding to the second antenna and the third antenna, respectively, wherein the first connection terminal and the second connection terminal are separately disposed on the printed circuit board.

Here, the first connection terminal and the second connection terminal may be separately disposed on the printed circuit board in such a way that the first connection pattern does not overlap the second antenna and the third antenna.

The first short-distance wireless communication may be magnetic secure transmission (MST) and the second short-distance wireless communication may be near field communication (NFC).

The first short-distance wireless communication may be near field communication (NFC) and the second short-distance wireless communication may be magnetic secure transmission (MST).

A separation distance between the second antenna and the third antenna may be a minimum of 1 millimeter (mm) or greater.

In this case, the second antenna and the third antenna may be disposed on the printed circuit board to maintain a deviation of the separation distance between the second antenna and the third antenna to a predetermined reference value or less.

A separation distance between the first antenna and the second antenna may be a minimum of 0.5 millimeter (mm) or greater.

Here, the first antenna and the second antenna may be disposed on the printed circuit board to maintain a deviation of a separation distance between the first antenna and the second antenna to a predetermined reference value or less.

The first antenna may be pattern-printed on each of opposite surfaces of the printed circuit board, and patterns printed on the opposite surfaces may be connected to each other through a penetration hole disposed in the printed circuit board.

The first antenna may be printed in a circular pattern with an inner diameter, and the first connection terminal may be disposed in the inner diameter.

The first connection terminal may be disposed between the first antenna and the second antenna.

In another embodiment, a wireless power reception device includes a multi-mode antenna module including a printed circuit board, a first antenna that is pattern-printed and disposed in a central region of the printed circuit board for wireless charging, a second antenna that is pattern-printed and disposed outside the first antenna for first short-distance wireless communication, a third antenna that is pattern-printed and disposed outside the second antenna not to overlap the second antenna for second short-distance wireless communication, a first connection terminal for connection of opposite ends of a first connection pattern corresponding to the first antenna, and a second connection terminal for connection of opposite ends of second and third connection patterns corresponding to the second antenna and the third antenna, respectively, and a control circuit board for receiving a signal from the multi-mode antenna module through the first connection terminal and the second connection terminal, wherein the first connection terminal and the second connection terminal are separately disposed on the printed circuit board.

In another embodiment, a multi-mode antenna module includes a printed circuit board, a first antenna that is pattern-printed and disposed in a central region of the printed circuit board for wireless charging, a second antenna that is pattern-printed and disposed outside the first antenna for first short-distance wireless communication, a third antenna that is pattern-printed and disposed outside the second antenna not to overlap the second antenna for second short-distance wireless communication, a first connection terminal for connection of opposite ends of a first connection pattern corresponding to the first antenna, and a second connection terminal for connection of opposite ends of second and third connection patterns corresponding to the second antenna and the third antenna, respectively, wherein the first connection terminal and the second connection terminal are separately disposed on the printed circuit board, and the third antenna includes a slit disposed in a length direction of a coil of the third antenna.

Here, the slit may have a width equal to or greater than 0.1 mm when a line width of the coil is equal to or greater than 0.5 mm.

A ratio of the width of the slit to the line width of the coil may be equal to or greater than 20%.

The slit may be configured by continuously disposing a plurality of slits in a length direction of the coil.

The third antenna may include outer and inner coils and the line width of the slit disposed in the outer coil may be larger than the line width of the slit disposed in the inner coil.

The line width of the slit may be increased toward an outer side from a central line of the coil.

The third antenna may include outer and inner coils, and an average line width of the slits respectively disposed on the outer slit may be larger than an average line width of the slit disposed in the inner coil.

The first connection terminal and the second connection terminal may be separately disposed on the printed circuit board in such a way that the first connection pattern does not overlap the second antenna and the third antenna.

The first short-distance wireless communication may be magnetic secure transmission (MST) and the second short-distance wireless communication may be near field communication (NFC).

The first short-distance wireless communication may be near field communication (NFC) and the second short-distance wireless communication may be magnetic secure transmission (MST).

A separation distance between the second antenna and the third antenna may be a minimum of 1 millimeter (mm) or greater.

In this case, the second antenna and the third antenna may be disposed on the printed circuit board to maintain a deviation of the separation distance between the second antenna and the third antenna to a predetermined reference value or less.

A separation distance between the first antenna and the second antenna may be a minimum of 0.5 millimeter (mm) or greater.

Here, the first antenna and the second antenna may be disposed on the printed circuit board to maintain a deviation of a separation distance between the first antenna and the second antenna to a predetermined reference value or less.

The first antenna may be pattern-printed on each of opposite surfaces of the printed circuit board, and patterns printed on the opposite surfaces may be connected to each other through a penetration hole disposed in the printed circuit board.

The first antenna may be printed in a circular pattern with an inner diameter, and the first connection terminal may be disposed in the inner diameter.

The first connection terminal may be disposed between the first antenna and the second antenna.

In another embodiment, a wireless power reception device includes a multi-mode antenna module including a printed circuit board, a first antenna that is pattern-printed and disposed in a central region of the printed circuit board for wireless charging, a second antenna that is pattern-printed and disposed outside the first antenna for first short-distance wireless communication, a third antenna that is pattern-printed and disposed outside the second antenna not to overlap the second antenna for second short-distance wireless communication, a first connection terminal for connection of opposite ends of a first connection pattern corresponding to the first antenna, and a second connection terminal for connection of opposite ends of second and third connection patterns corresponding to the second antenna and the third antenna, respectively, and a control circuit board for receiving a signal from the multi-mode antenna module through the first connection terminal and the second connection terminal, wherein the first connection terminal and the second connection terminal are separately disposed on the printed circuit board, and the third antenna includes a slit disposed in a length direction of a coil of the third antenna.

In another embodiment, a wireless power receiver includes an antenna for combine use of magnetic security transmission (MST) and wireless power transmission (WPT), a determination unit configured to determine an antenna mode based on a radio signal received through the antenna for combined use, and a switching unit configured to select a transmission path of the radio signal according to the determined antenna mode.

In some embodiments, the wireless power receiver may further include a near field communication (NFC) antenna.

In some embodiments, the determination unit may determine an antenna mode using a magnitude of current or voltage generated the antenna for combined use according to the radio signal.

In some embodiments, the determination unit may determine an antenna mode using variation of current or voltage generated the antenna for combined use according to the radio signal.

In some embodiments, the determination unit may determine an antenna mode using a ping signal received from the antenna for combined use.

In some embodiments, the determination unit may determine an antenna mode using a magnitude or frequency of the ping signal.

In some embodiments, the antenna mode may include a magnetic security transmission mode and a wireless power transmission mode.

In some embodiments, when the antenna mode is determined as the magnetic security transmission mode, the multi-mode antenna module may further include a first signal processing unit configured to receive the radio signal from the determination unit, and a second signal processing unit configured to receive the radio signal from the determination unit when the antenna mode is determined as the wireless power transmission mode.

In some embodiments, the wireless power receiver may further include an MST module configured to receive a first control signal generated from the first signal processing unit, and a wireless charging module configured to receive a second control signal generated from the second signal processing unit.

In some embodiments, the wireless power receiver may further include a rectifying unit configured to convert a voltage applied from the determination unit into a voltage that is determined according to the antenna mode.

In some embodiments, when the antenna for combined use receives a radio signal including a message indicating termination of the antenna mode, the switching unit may block the selected transmission path.

In another embodiment, a method of controlling a wireless power receiver includes receiving a radio signal by an antenna for combined use of magnetic security transmission (MST) and wireless power transmission (WPT), determining an antenna mode based on the radio signal, and switching selection of a transmission path of the radio signal according to the determined antenna mode.

In some embodiments, the antenna for combined use may include a near field communication (NFC) antenna.

In some embodiments, the determining of the antenna mode may include determining an antenna mode using current or voltage generated from the antenna for combined use according to the radio signal.

In some embodiments, the determining of the antenna mode may include determining an antenna mode variation of current or voltage generated from the antenna for combined use according to the radio signal.

In some embodiments, the determining of the antenna mode may include determining an antenna mode using a ping signal received from the antenna for combined use.

In some embodiments, the determining of the antenna mode may include determining an antenna mode using a period or frequency of the ping signal.

In some embodiments, the determining of the antenna mode may include determining the antenna mode as any one of a magnetic security transmission mode and a wireless power transmission mode.

In some embodiments, the method may further include receiving the radio signal by a first signal processing unit through the switching unit upon determining the antenna mode as the magnetic security transmission mode, and receiving the radio signal by the second signal processing unit through the switching upon determining the antenna mode as the wireless power transmission mode.

In some embodiments, the method may further include receiving a first control signal generated from the first signal processing unit by the MST module, and receiving a second control signal generated from the second signal processing unit by a wireless charging module.

In some embodiments, the method may further include converting a voltage applied from the determination unit into a voltage determined according to the antenna mode by a rectifying unit.

In some embodiments, the method may further include blocking the selected transmission path by the switching unit upon receiving a radio signal indicating termination of the antenna mode by the antenna for combined use.

In some embodiments, a computer readable recording medium having recorded thereon a program for executing the aforementioned method may be provided.

It is to be understood that both the foregoing general description and the following detailed description of the embodiments are exemplary and explanatory and are intended to provide further explanation of the embodiments as claimed.

### Advantageous Effects

The method and apparatus according to embodiments may have the following advantageous effects.

Embodiments provide a multi-mode antenna and a wireless power reception device using the same.

Embodiments provide a multi-mode antenna and a wireless power reception device including the multi-mode antenna module installed therein, for minimizing an interference phenomenon between antennas to maximize wireless charging efficiency and recognition performance.

Embodiments provide a multi-mode antenna and a wireless power reception device including the multi-mode antenna module installed therein, for reducing resistance of a coil itself to enhance recognition sensitivity and performance by disposing a slit inside the coil of the antenna.

According to embodiments, an antenna for combined use of magnetic security transmission (MST) and wireless power transmission (WPT) may be used due to a spatial restriction and, thus, a burden of disposing in one terminal may be reduced.

According to embodiments, an antenna for combined use of magnetic security transmission (MST) and wireless power transmission (WPT) may be used and, thus, a spare space may be formed to reduce interference between antennas other than the antenna for combined use.

According to embodiments, an antenna for combined use of magnetic security transmission (MST) and wireless power transmission (WPT) may be used and, thus, devices that perform the same operation other than antennas may be shared.

According to embodiments, the number of required components may be reduced by sharing devices, and a spare space is formed in a terminal along with device sharing, thereby achieving miniaturization.

It will be appreciated by persons skilled in the art that that the effects that could be achieved with the embodiments are not limited to what has been particularly described hereinabove and other advantages of the embodiments will be more clearly understood from the following detailed description taken in conjunction with the accompanying drawings.

### DESCRIPTION OF DRAWINGS

The accompanying drawings, which are included to provide a further understanding of the present disclosure, illustrate embodiments of the present disclosure and together with the description serve to explain the principle of the present disclosure.

In the drawings:

FIG. 1 is a block diagram for explanation of a wireless charging system according to an embodiment;

FIG. 2 is a block diagram for explanation of a structure of a wireless power reception device according to an embodiment;

FIGS. 3 to 6 are diagrams for explanation of a structure of a multi-mode antenna module according to an embodiment;

FIG. 7 is a diagram for explanation of a layered structure of a wireless power reception device according to an embodiment;

FIG. 8 is a diagram of an experiment result showing a recognition region of magnetic security transmission in a wireless power reception device with a multi-mode antenna module installed therein according to an embodiment;

FIG. 9 is a table showing an experiment result for comparison of a recognition distance before and after performance enhancement with respect to various NFC standard types;

FIG. 10 is a block diagram for explanation of a wireless power reception device according to another embodiment;

FIGS. 11 and 12 are diagrams for explanation of a structure of a multi-mode antenna module according to another embodiment;

FIG. 13 is a diagram showing a structure of an antenna according to an embodiment;

FIG. 14 is a diagram showing a structure of an antenna according to another embodiment;

FIG. 15 is a diagram showing a structure of an antenna according to another embodiment;

FIG. 16 is a block diagram for explanation of a wireless charging system according to another embodiment;

FIG. 17 is a state transition diagram for explanation of a wireless power transmission procedure defined in the wireless power consortium (WPC) standard;

FIG. 18 is a state transition diagram for explanation of a wireless power transmission procedure defined in the power matters alliance (PMA) standard;

FIG. 19 is a block diagram for explanation of a structure of a wireless power transmission system according to an embodiment;

FIG. 20 is an equivalent circuit diagram of a wireless power transmission system according to an embodiment;

FIG. 21 is a state transition diagram for explanation of a state transition procedure of a wireless power transmitter using an electromagnetic resonance mode according to an embodiment;

FIG. 22 is a state transition diagram of a wireless power receiver using an electromagnetic resonance mode according to an embodiment;

FIG. 23 is a flowchart for explanation of a wireless charging procedure using an electromagnetic resonance mode according to an embodiment;

FIG. 24 is a structure diagram for explanation of a wireless power receiver including an antenna for combined use of magnetic security transmission (MST) and wireless power transmission (WPT) according to an embodiment;

FIG. 25 is a flowchart for explanation of a method of controlling a wireless power receiver including an antenna for combined use of magnetic security transmission (MST) and wireless power transmission (WPT) according to an embodiment;

FIG. 26 is a diagram for explanation of an operation of identifying a wireless communication signal received from an antenna for combined use of magnetic security transmission (MST) and wireless power transmission (WPT) according to an embodiment; and

FIG. 27 is a diagram for explanation of antenna arrangement based on use of an antenna for combined use of magnetic security transmission (MST) and wireless power transmission (WPT) according to an embodiment.

### BEST MODE

In one embodiment, a multi-mode antenna module includes a printed circuit board, a first antenna that is pattern-printed and disposed in a central region of the printed circuit board for wireless charging, a second antenna that is pattern-printed and disposed outside the first antenna for first short-distance wireless communication, a third antenna that is pattern-printed and disposed outside the second antenna not to overlap the second antenna for second short-distance wireless communication, a first connection terminal for connection of opposite ends of a first connection pattern corresponding to the first antenna, and a second connection terminal for connection of opposite ends of second and third connection patterns corresponding to the second antenna and the third antenna, respectively, wherein the first connection terminal and the second connection terminal are separately disposed on the printed circuit board.

### Mode for Invention

Hereinafter, devices and various methods, to which embodiments of the disclosure are applied, will be described in more detail with reference to the accompanying drawings. The suffixes “module” and “unit” of elements herein are used for convenience of description and thus can be used interchangeably and do not have any distinguishable meanings or functions.

In description of exemplary embodiments, it will be understood that, when an element is referred to as being “on” or “under” and “before” or “after” another element, the element can be directly on another element or intervening elements may be present. In addition, when an element is referred to as being “on” or “under” another element, this may include the meaning of an upward direction or a downward direction based on one component.

In the following description of the disclosure, for convenience of description, an apparatus for wirelessly transmitting power in a wireless power system may be used interchangeably with a wireless power transmitter, a wireless power transmission apparatus, a wireless power transmission device, a transmission end, a transmitter, a transmission apparatus, a transmission side, a wireless power transmission apparatus, etc. In addition, for convenience of description, an apparatus for wirelessly receiving power from a wireless power transmission apparatus may be used interchangeably with a wireless power reception apparatus, a wireless power receiver, a wireless power reception device, a reception terminal, a reception side, a reception apparatus, a receiver terminal, etc.

A transmitter according to the disclosure may be configured in the form of a pad, a cradle, an access point (AP), a small base station, a stand, a ceiling insert type, a wall-hanging type, or the like. One transmitter may transmit power to a plurality of wireless power reception apparatuses. To this end, a wireless power transmitter may include at least one wireless power transmission element. Here, the wireless power transmission element may use various wireless power transmission standards based on an electromagnetic induction method of charging according to the electromagnetic induction principle that a magnetic field is generated from a coil of a power transmission end and electricity is induced from a coil of a reception end under the influence of the magnetic field. Here, the wireless power transmission element may include wireless charging technology of an electromagnetic induction method defined in wireless power consortium (WPC) and power matters alliance (PMA) which are wireless charging technology standard organizations.

In addition, a wireless power receiver according to an embodiment may include at least one wireless power reception element and may simultaneously and wirelessly receive power from two or more wireless power transmitters. Here, the wireless power reception element may include wireless charging technology of an electromagnetic induction method defined in wireless power consortium (WPC) and power matters alliance (PMA) which are wireless charging technology standard organizations.

A receiver according to the disclosure may be used in a small-size electronic apparatus such as a mobile phone, a smartphone, a laptop computer, a digital broadcasting terminal, a personal digital assistants (PDA), a portable multimedia player (PMP), a navigation system, an MP3 player, an electric toothbrush, a radio frequency identification (RFID) tag, an illumination apparatus, a remote controller, a bobber, or a wearable device including a smart watch, without being limited thereto, and may be any device that includes a wireless power reception element that is rechargeable by a battery.

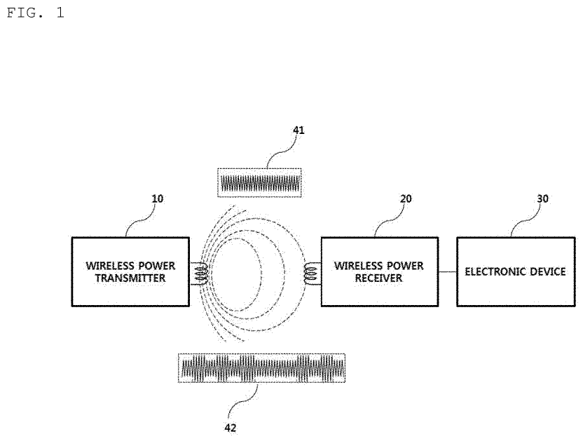

FIG. 1 is a block diagram for explanation of a wireless charging system according to an embodiment.

Referring to FIG. 1, the wireless charging system may broadly include a wireless power transmitter 10 for wirelessly transmitting power, a wireless power receiver 20 for receiving the transmitted power, and an electronic device 30 for supplying the received power.

Here, a load (not shown) that is a rechargeable battery may be installed in the electronic device 30, and received power may be charged in the load of the electronic device 30.

For example, the wireless power transmitter 10 and the wireless power receiver 20 may perform in-band communication for exchanging information using the same frequency band as an operation frequency used in wireless power transmission.

In in-band communication, upon receiving a power signal 41 transmitted from the wireless power transmitter 10, the wireless power receiver 20 may modulate the received power signal and may transmit the modulated signal 42 to the wireless power transmitter 10.

As another example, the wireless power transmitter 10 and the wireless power receiver 20 may also perform out-of-band communication for exchanging information using a different frequency band from the operation frequency used in wireless power transmission.

For example, the information exchanged between the wireless power transmitter 10 and the wireless power receiver may include identification information, configuration information, state information, various control information items, and so on. Here, detailed information exchanged between the transmitter and the receiver will be more clearly understood through a description of embodiments that will be described.

Communication in the wireless charging system may provide bidirectional communication without being limited thereto, and according to another embodiment may provide directional communication such as unidirectional communication or half-duplex communication.

For example, unidirectional communication may be a communication method of transmitting information only to the wireless power transmitter 10 from the wireless power receiver 20, without being limited thereto, and may alternatively be a communication method of transmitting information to the wireless power receiver 20 by the wireless power transmitter 10.

In the half-duplex communication method, bidirectional communication is enabled between the wireless power receiver 20 and the wireless power transmitter 10, but only any one of the wireless power receiver 20 and the wireless power transmitter 10 is capable of transmitting information at any one time point.

The wireless power receiver 20 according to an embodiment may acquire various state information items of the electronic device 30. For example, the state information of the electronic device 30 may include current power usage information, information for identifying a currently running application, CPU usage information, battery charge state information, battery output voltage/current information, and so on, without being limited thereto, and may include any information that is capable of being acquired from the electronic device 30 and being used in wireless power control.

The wireless power receiver 20 according to an embodiment may include a near field communication (NFC) or radio frequency identification (RFID) communication antenna, a short-distance communication antenna such as a Bluetooth communication antenna, and a security communication antenna for security communication such as finance or approval as well as a power reception antenna for wireless power reception.

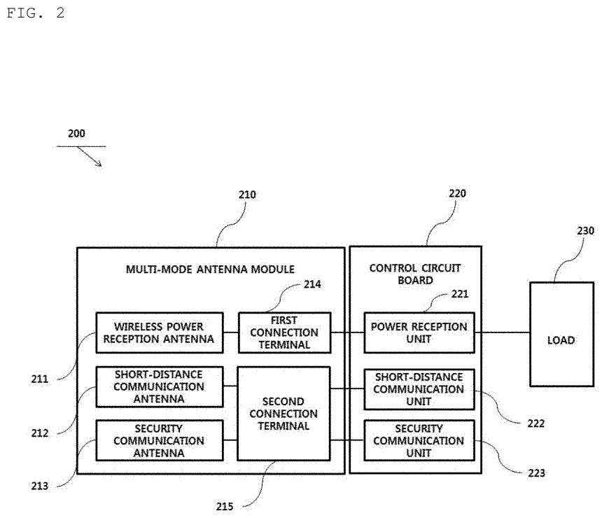

FIG. 2 is a block diagram for explanation of a structure of a wireless power reception device according to an embodiment.

Referring to FIG. 2, a wireless power reception device 200 may broadly include a multi-mode antenna module 210, a control circuit board 220, and a load 230.

The multi-mode antenna module 210 may include a plurality of antennas and a connection terminal. For example, the plurality of antennas may include a wireless power reception antenna 211 for wireless power reception, a short-distance communication antenna 212 for short-distance wireless communication, and a security communication antenna 213 for security communication without being limited thereto and, other antennas may be added according to the purpose of design of one of the ordinary skill in the art. In addition, the connection terminal may be configured to couple antenna lead wires. In order to minimize interference between antennas and to minimize an arrangement area of a device on a printed circuit board, a plurality of connection terminals may be physically spaced apart from each other.

According to the present embodiment, an example in which a lead wire of the wireless power reception antenna 211 is coupled to a first connection terminal 214 and lead wires of the short-distance communication antenna 212 and the security communication antenna 213 are coupled to a second connection terminal 215 will be described.

An arrangement form of an antenna pattern printed on a printed circuit board would be more clearly understood with reference to drawings that will be described below.

A wireless power signal received through the wireless power reception antenna 211 may be transferred to a power reception unit 221 included in the control circuit board 220 through the first connection terminal 214.

The power reception unit 221 may include a micro processor or a controller (not shown) in which predetermined software is installed to monitor a power reception state in real time and to control power as well as a hardware device such as a rectifier (not shown) for converting an alternating current (AC) power signal received through the wireless power reception antenna 211 into a direct current (DC) power signal or a DC-DC converter (not shown) for converting a DC voltage output from the rectifier into a specific DC voltage required by a load.

For example, when the wireless power reception device 200 performs in-band communication with a wireless power transmission device, the power reception unit 221 may include a controller (not shown), a decoder (not shown) for decoding a control signal from the received power signal, a modulator for modulating a predetermined state information and control signal generated by the controller and transmitting the state information and control signal to the wireless power transmission device via in-band communication, or the like.

As another example, when the wireless power reception device 200 performs out-of-band communication with a wireless power transmission device, the power reception unit 221 may include a communication unit (not shown) for performing control to demodulate various control signals received through a separately configured out-of-band communication antenna (not shown), to modulate an internally generated control message and, then, to transmit the modulated signal through an out-of-band communication antenna. Needless to say, the short-distance communication antenna 212 may be used as an out-of-band communication antenna without being limited thereto.

The power reception unit 221 may transfer the processed wireless power signal to the load 230.

The power reception unit 221 may dynamically control electric energy transferred to the load 230 and electric energy required by a wireless power transmission device according to a current charging state of the load 230, internal temperature, intensity of a voltage output from the rectifier, or the like.

A radio signal received through the short-distance communication antenna 212 may be transferred to a short-distance communication unit 222 installed in the control circuit board 220 through the second connection terminal 215.

The short-distance communication unit 222 may include a controller (not shown), a decoder (not shown) for decoding the received radio signal and transferring the radio signal to the controller, a modulator (not shown) for modulating a message generated by the controller (not shown) into a radio signal and transferring the radio signal to the short-distance communication antenna 212 through the second connection terminal 215, or the like. For example, the short-distance communication unit 222 may process an NFC signal without being limited thereto and, the short-distance communication unit 222 may process a Bluetooth communication signal or the like.

A radio signal received through the security communication antenna 213 may be transferred to a security communication unit 223 installed in the control circuit board 220 through the second connection terminal 215.

The security communication unit 223 may include a controller (not shown), a decoder (not shown) for decoding the received radio signal and transferring the radio signal to the controller, a modulator (not shown) for modulating a message generated by the controller into a radio signal and transmitting the radio signal to the security communication antenna 213 through the second connection terminal 215, and so on. For example, a signal processing function using a magnetic secure transmission (MST) method for mobile approval may be installed in the security communication unit 223 without being limited thereto and, it may be noted that various types of fintech technologies such as Apple pay or(and) Google (Android) are installed.

According to an embodiment, a shield member may be disposed between the multi-mode antenna module 210 and the control circuit board 220.

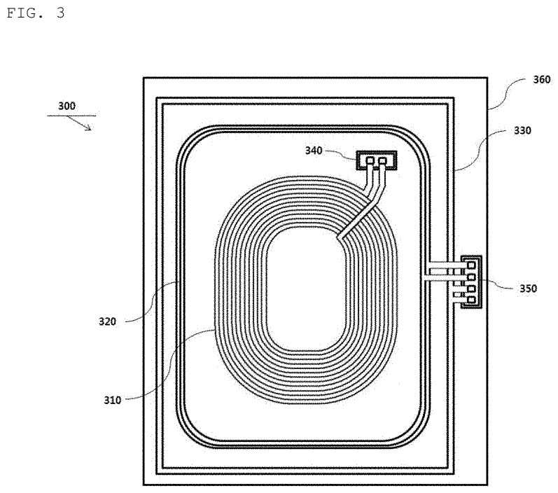

FIG. 3 is a diagram for explanation of a structure of a multi-mode antenna module according to an embodiment.

Referring to FIG. 3, a multi-mode antenna module 300 may include a printed circuit board 360, a first antenna 310, a second antenna 320, a third antenna 330, a first connection terminal 340, and a second connection terminal 350.

In detail, the multi-mode antenna module 300 according to the present embodiment may include the printed circuit board 360, the first antenna 310 that is pattern-printed and disposed in a central region of the printed circuit board 360 for wireless charging, the second antenna 320 that is pattern-printed and disposed outside the first antenna 310 in order to perform first short-distance wireless communication, the third antenna 330 that is pattern-printed and disposed outside the second antenna 320 not to overlap the second antenna 320 in order to perform second short-distance wireless communication, the first connection terminal 340 for connection of opposite ends of a first connection pattern corresponding to the first antenna 310, and the second connection terminal 350 for connection of opposite ends of second and third connection patterns corresponding to the second antenna 320 and the third antenna 330, respectively.

Here, the first connection terminal 340 and the second connection terminal 350 may be physically and separately disposed on the printed circuit board 350. For example, the first connection terminal 340 and the second connection terminal 350 may be physically and separately disposed on the printed circuit board 360 in such a way that the first connection pattern does not overlap the second antenna 320 and the third antenna 330.

A connection pattern of each antenna may be formed as a lead wire that extends from opposite ends of a corresponding antenna or may be branched from a specific position of the corresponding antenna. Here, a connection pattern of each antenna and a position in which a connection terminal is disposed may be configured to minimize the length of the connection pattern.

For example, the first short-distance wireless communication may be magnetic secure transmission (MST) and the second short-distance wireless communication may be near field communication (NFC). Here, MST may be performed in a band of 3.24 MHz and NFC may be performed in a band of 13.56 MHz.

As another example, the first short-distance wireless communication may be near field communication (NFC) and the second short-distance wireless communication may be magnetic secure transmission (MST).

As another example, the first short-distance wireless communication and the second short-distance wireless communication may each correspond to any one of NFC, RFID communication, Bluetooth communication, ultra wideband (UWB) communication, MST communication, Apple pay communication, and Google pay communication.

Patterns of a corresponding antenna may be disposed on the printed circuit board 360 to maintain a separation distance between the second antenna 320 and the third antenna 330 to a minimum of 1 millimeter (mm) or greater. In this case, the second antenna 320 and the third antenna 330 may be disposed on the printed circuit board 360 to maintain a deviation of a separate distance between the second antenna 320 and the third antenna 330 to a predetermined first reference value or less.

Patterns of a corresponding antenna may be disposed on the printed circuit board 360 to maintain a separate distance between the first antenna 310 and the second antenna 320 to a minimum of 0.5 millimeter (mm) or greater. In this case, the first antenna 310 and the second antenna 320 may be disposed on the printed circuit board 360 to maintain a deviation of a separate distance between the first antenna 310 and the second antenna 320 to a predetermined second reference value or less.

For example, the first antenna 310 may be pattern-printed on each of opposite surfaces of the printed circuit board 360, and the patterns printed on the opposite surfaces may be connected to each other through a penetration hole (not shown) disposed in the printed circuit board 360. As such, resistance components of a first antenna may be reduced and, accordingly, reception sensitivity of the corresponding antenna may be enhanced.

As another example, the second antenna 320 may be pattern-printed on each of opposite surfaces of the printed circuit board 360, and the patterns printed on the opposite surfaces may be connected to each other through a penetration hole (not shown) disposed in the printed circuit board 360. As such, resistance components of a second antenna may be reduced and, accordingly, reception sensitivity of the corresponding antenna may be enhanced.

As another example, the third antenna 330 may be pattern-printed on each of opposite surfaces of the printed circuit board 360, and the patterns printed on the opposite surfaces may be connected to each other through a penetration hole (not shown) disposed in the printed circuit board 360. As such, resistance components of a third antenna may be reduced and, accordingly, reception sensitivity of the corresponding antenna may be enhanced.

As another example, at least one of the first antenna 310, the second antenna 320, and the third antenna 330 may be pattern-printed on each of opposite surfaces of the printed circuit board 360, and the patterns printed on the opposite surfaces may be connected to each other through a penetration hole (not shown) disposed in the printed circuit board 360. As such, resistance components of the corresponding antenna may be reduced and, accordingly, reception sensitivity of the corresponding antenna may be enhanced.

As shown in FIG. 3, the first antenna 310 may be printed on the printed circuit board 360 in a circular pattern with a predetermined inner diameter and the first connection terminal may be disposed outside the inner diameter but, this is merely an embodiment and, various arrangement forms will be described with reference to drawings that will be described below.

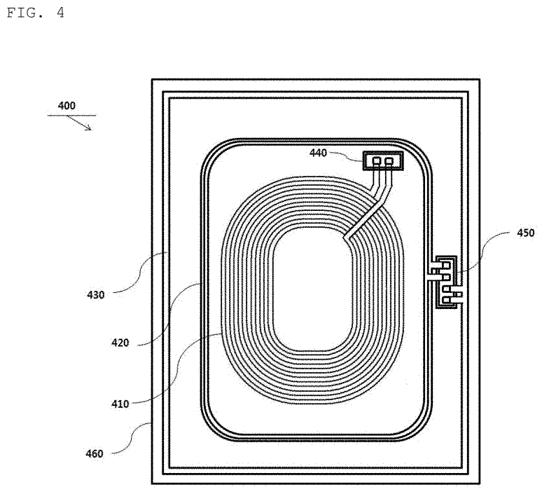

FIG. 4 is a diagram for explanation of a structure of a multi-mode antenna module according to another embodiment.

Compared with FIG. 3, a multi-mode antenna module 400 shown in FIG. 4 may be similar to FIG. 3 in that a first connection terminal 450 and a second connection terminal 460 are physically and separately disposed on a printed circuit board 410 but, the multi-mode antenna module 400 shown in FIG. 4 may be different from FIG. 3 in that the second connection terminal 450 is disposed between a second antenna 420 and a third antenna 430.

Compared with FIG. 3, in the multi-mode antenna module 400 shown in FIG. 4, a second connection pattern corresponding to the second antenna 420 may not overlap the third antenna 430 and, thus, an interference phenomenon due to a magnetic field generated therebetween may be minimized on the second antenna 420 and the third antenna 430.

In the multi-mode antenna module 400 shown in FIG. 4, a distance between the second antenna 420 and the second connection terminal 450 may also be minimized.

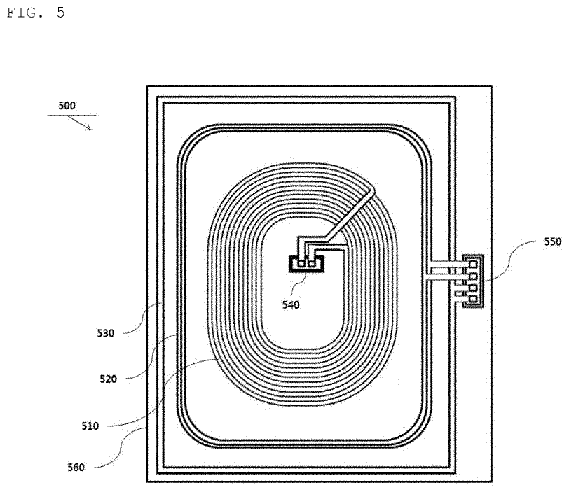

FIG. 5 is a diagram for explanation of a structure of a multi-mode antenna module according to another embodiment.

Compared with FIG. 3, a multi-mode antenna module 500 shown in FIG. 5 may be similar to FIG. 3 in that a first connection terminal 550 and a second connection terminal 560 are physically and separately disposed on a printed circuit board 510 but, multi-mode antenna module 500 shown in FIG. 5 is different from FIG. 3 in that the first connection terminal 540 is disposed inside an inner diameter of a first antenna 510.

Compared with FIG. 3, in the multi-mode antenna module 500 shown in FIG. 5, it may be advantageous that a space between the first antenna 510 and a second antenna 520 is ensured and an unused space of the first antenna 510 is effectively used. In addition, a separation distance from the second antenna 520 may be increased and, thus, an interference phenomenon due to the first antenna 510 may be advantageously minimized.

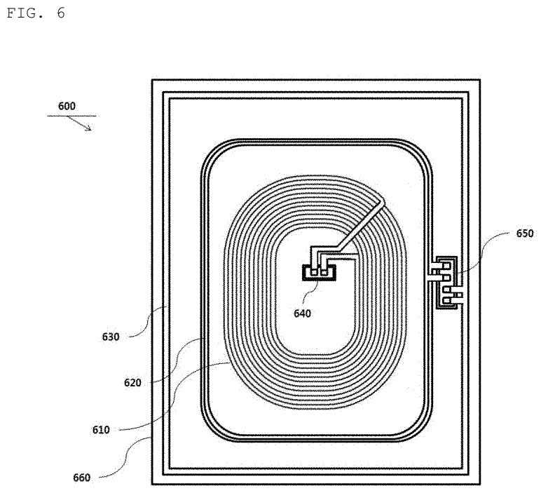

FIG. 6 is a diagram for explanation of a structure of a multi-mode antenna module according to another embodiment.

Compared with FIG. 3, a multi-mode antenna module 600 shown in FIG. 6 may be similar to FIG. 3 in that a first connection terminal 650 and a second connection terminal 660 are physically and separately disposed on a printed circuit board 610 but, the multi-mode antenna module 600 shown in FIG. 6 may be different from FIG. 3 in that the first connection terminal 640 is disposed inside an inner diameter of a first antenna 610 and the second connection terminal 650 is disposed between a second antenna 620 and a third antenna 630.

Compared with FIG. 3, in the multi-mode antenna module 600 shown in FIG. 6, it may be advantageous that a space between the first antenna 610 and the second antenna 620 is ensured and an unused space of the first antenna 610 is effectively used. In addition, a separation distance from the second antenna 620 may be increased and, thus, an interference phenomenon due to the first antenna 610 may be advantageously minimized.

Compared with FIG. 3, in the multi-mode antenna module 600 shown in FIG. 6, a second connection pattern corresponding to the second antenna 620 may not overlap the third antenna 630 and, thus, an interference phenomenon due to a magnetic field generated therebetween may be minimized on the second antenna 420 and the third antenna 430.

In the multi-mode antenna module 600 shown in FIG. 6, a distance the second antenna 620 and the second connection terminal 650 may also be minimized.

In the aforementioned multi-mode antenna modules according to the embodiments shown in FIGS. 2 to 6, a frequency transition phenomenon generated between antennas with different operation frequencies may be minimized by separately disposing connection terminals and, thus, a recognition rate of short-distance wireless communication—which includes, for example, NFC or MST—may be advantageously enhanced.

In the multi-mode antenna modules according to the embodiments shown in FIGS. 2 to 6, interference between antennas may be minimized by separately disposing connection terminals and, thus, antenna resistance may be reduced and, thus, wireless charging efficiency may be advantageously enhanced.

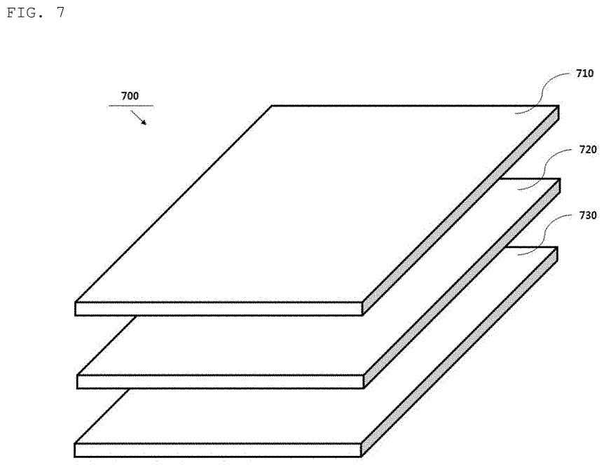

FIG. 7 is a diagram for explanation of a layered structure of a wireless power reception device according to an embodiment.

Referring to FIG. 7, a wireless power reception device 700 may include a multi-mode antenna module 710, a shield module 720, and a control circuit board 730.

The multi-mode antenna module 710 may be any one of the multi-mode antenna modules shown in FIGS. 3 to 6.

For example, the wireless power reception device 700 may include a multi-mode antenna module including a printed circuit board, a first antenna that is pattern-printed and disposed in a central region of the printed circuit board for wireless charging, a second antenna that is pattern-printed and disposed outside the first antenna in order to perform first short-distance wireless communication, a third antenna that is pattern-printed and disposed outside the second antenna not to overlap the second antenna in order to perform second short-distance wireless communication, a first connection terminal for connection of opposite ends of a first connection pattern corresponding to the first antenna, and a second connection terminal for connection of opposite ends of second and third connection patterns corresponding to the second antenna and the third antenna, respectively, the control circuit board 730 for control of an operation of a multi-mode antenna, and a shield module disposed between the multi-mode antenna module 710 and the control circuit board 730 in order to shield an electromagnetic wave generated by the multi-mode antenna module 710.

The control circuit board 730 may receive a signal received through an antenna through the first connection terminal and the second connection terminal.

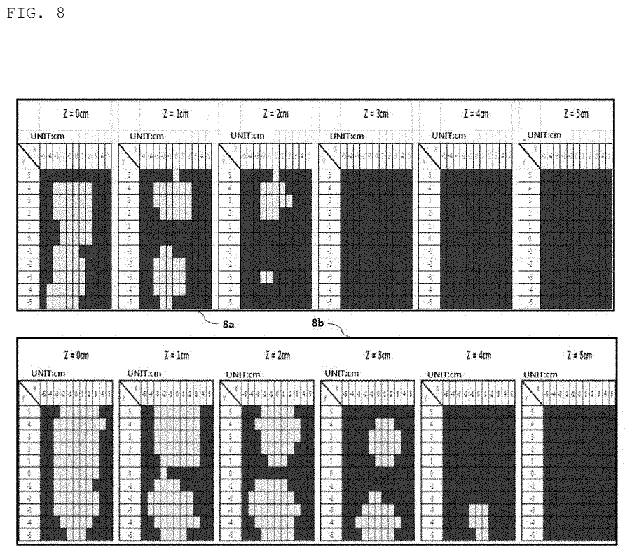

FIG. 8 is a diagram of an experiment result showing a recognition region of magnetic security transmission in a wireless power reception device with a multi-mode antenna module installed therein according to an embodiment.

Referring to FIG. 8, reference numeral 8a shows a recognition region of magnetic security transmission in a conventional wireless power reception device including a multi-mode antenna module in which connection terminals are not separately disposed and an overlapping region is present between antennas. Reference numeral 8b shows a recognition region of magnetic security transmission in a wireless power reception device including a multi-mode antenna module according to an embodiment.

Referring to reference numeral 8a, the conventional wireless power reception device may recognize up to a point spaced apart from a charging bed by 2 cm in a height direction—i.e., Z axis—. On the other hand, referring to reference numeral 8b, the wireless power reception device according to an embodiment may recognize up to a point spaced apart from the charging bed by 4 cm in the height direction—i.e., Z axis—. That is, according to the present disclosure, with regard to the recognition region of magnetic security transmission, performance enhancement of 100% or greater may be expected compared with the conventional technology.

Comparing reference numerals 8a and 8b, it may be seen that the wireless power reception device according to the present disclosure has a wider recognition area on a charging bed than the conventional wireless power reception device with respect to the same separation distance.

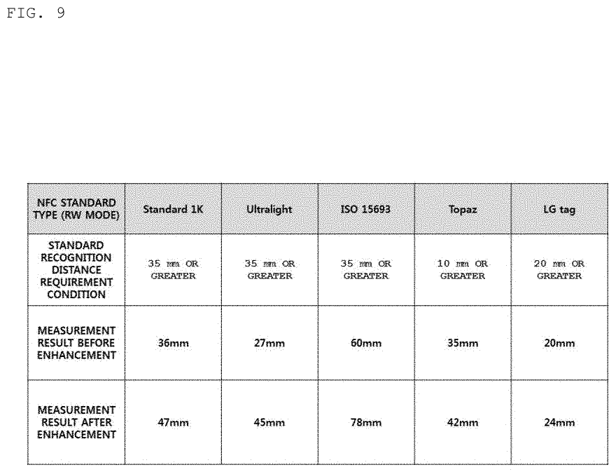

FIG. 9 is a table showing an experiment result for comparison of a recognition distance before and after performance enhancement with respect to various NFC standard types.

As seen from FIG. 9, with regard to the NFC recognition distance of the wireless power reception devices including the multi-mode antenna modules according to the embodiments shown in FIGS. 2 to 7, a recognition distance is increased compared with a measurement result before performance enhancement with respect to various NFC standard types-i.e., various read/write (RW) mode-. In addition, it may be seen that the NFC recognition distance measured in the wireless power reception device according to the present disclosure satisfies a standard recognition distance requirement condition in all NFC standard types.

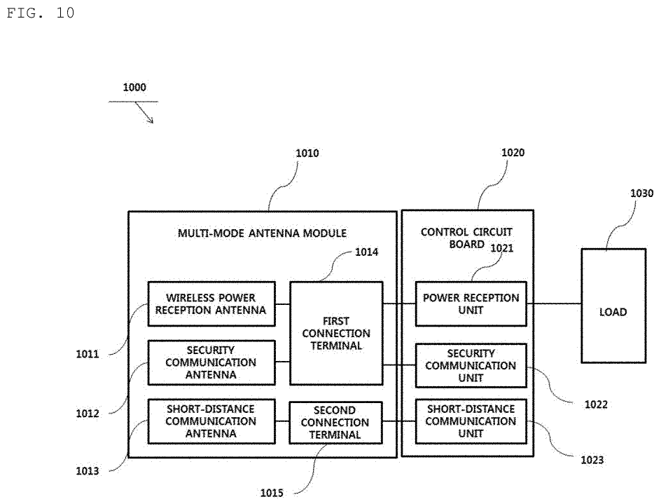

FIG. 10 is a block diagram for explanation of a wireless power reception device according to another embodiment.

Referring to FIG. 10, a wireless power reception device 1000 may broadly include a multi-mode antenna module 1010, a control circuit board 1020, and a load 1030.

The multi-mode antenna module 1010 may include a plurality of antennas and a plurality of connection terminals. For example, the plurality of antennas may include a wireless power reception antenna 1011 for wireless power reception, a short-distance communication antenna 1012 for short-distance wireless communication, and a security communication antenna 1013 for security communication without being limited thereto and, other antennas may be added according to the purpose of design of one of the ordinary skill in the art. In addition, the connection terminal may be configured to couple antenna lead wires. In order to minimize interference between antennas with different operation frequencies and to minimize an arrangement area of a device on a printed circuit board, a plurality of connection terminals may be physically spaced apart from each other.

According to the present embodiment, an example in which lead wires of the wireless power reception antenna 1011 and the security communication antenna 1012 are coupled to a first connection terminal 1014 and a lead wire of the security communication antenna 1013 is coupled to a second connection terminal 1015 will be described.

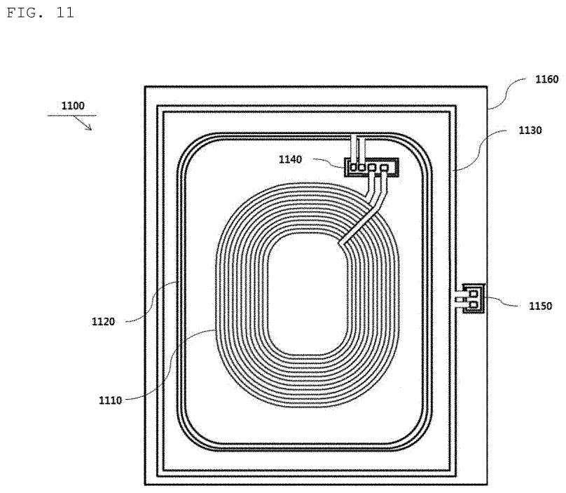

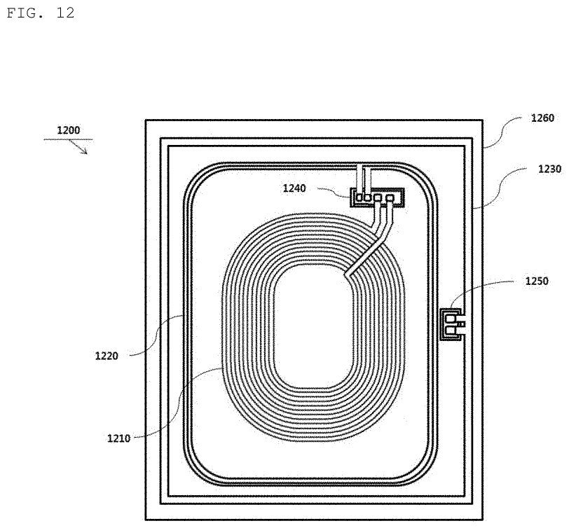

An arrangement form of an antenna pattern printed on a printed circuit board would be more clearly understood with reference to FIGS. 11 and 12.

A wireless power signal received through the wireless power reception antenna 1011 may be transferred to a power reception unit 1021 included in the control circuit board 1020 through the first connection terminal 1014.

The power reception unit 1021 may include a micro processor or a controller (not shown) in which predetermined software is installed to monitor a power reception state in real time and to control power as well as a hardware device such as a rectifier (not shown) for converting an alternating current (AC) power signal received through the wireless power reception antenna 1011 into a direct current (DC) power signal or a DC-DC converter (not shown) for converting a DC voltage output from the rectifier into a specific DC voltage required by a load.

For example, when the wireless power reception device 1000 performs in-band communication with a wireless power transmission device, the power reception unit 1021 may include a controller (not shown), a decoder (not shown) for decoding a control signal from the received power signal, a modulator for modulating a predetermined state information and control signal generated by the controller and transmitting the state information and control signal to the wireless power transmission device via in-band communication, or the like.

As another example, when the wireless power reception device 1000 performs out-of-band communication with a wireless power transmission device, the power reception unit 1021 may include a communication unit (not shown) for performing control to demodulate various control signals received through a separately configured out-of-band communication antenna (not shown), to modulate an internally generated control message and, then, to transmit the modulated signal through an out-of-band communication antenna. Needless to say, the short-distance communication antenna 1013 may be used as an out-of-band communication antenna without being limited thereto and, a separate additional short-distance communication antenna -e.g., a Bluetooth communication antenna- may be included.

The power reception unit 1021 may transfer the processed wireless power signal to the load 1030.

The power reception unit 1021 may dynamically control electric energy transferred to the load 1030 and electric energy required by a wireless power transmission device according to a current charging state of the load 1030, internal temperature, intensity of a voltage output from the rectifier, or the like.

A radio signal received through the security communication antenna 1012 may be transferred to a security communication unit 1022 installed in the control circuit board 1020 through the first connection terminal 1014.

A radio signal received through the short-distance communication antenna 1013 may be transferred to a short-distance communication unit 1023 installed in the control circuit board 1020 through the second connection terminal 1015.

The short-distance communication unit 1023 may include a controller (not shown), a decoder (not shown) for decoding the received radio signal and transferring the controller, a modulator (not shown) for modulating a message generated by the controller (not shown) into a radio signal and transferring the radio signal to the short-distance communication antenna 1013 through the second connection terminal 1015, or the like. For example, the short-distance communication unit 1023 may process an NFC signal without being limited thereto and, may also process other short-distance wireless communication signals such as a Bluetooth communication signal, or the like.

The security communication unit 1022 may include a controller (not shown), a decoder (not shown) for decoding the received radio signal and transferring the radio signal to the controller, a modulator (not shown) for modulating a message generated by the controller and transmitting the radio signal to the security communication antenna 1012 through the first connection terminal 1014, or the like. For example, a signal processing function using a magnetic secure transmission (MST) method for mobile approval may be installed in the security communication unit 1022 without being limited thereto and, it may be noted that various types of fintech technologies such as Apple pay or(and) Google

(Android) are installed.

According to an embodiment, a shield member (not shown) may be disposed between the multi-mode antenna module 1010 and the control circuit board 1020.

FIGS. 11 and 12 are diagrams for explanation of a structure of a multi-mode antenna module according to another embodiment.

Referring to FIG. 11, a multi-mode antenna module 1100 may include a printed circuit board 1160, a first antenna 1110, a second antenna 1120, a third antenna 1130, a first connection terminal 1140, and a second connection terminal 1150.

In detail, the multi-mode antenna module 1000 according to the present embodiment may include a printed circuit board 1060, a first antenna 1010 that is pattern-printed and disposed in a central region of the printed circuit board 360 for wireless charging, a second antenna 1020 that is pattern-printed and disposed outside the first antenna 1010 in order to perform first short-distance wireless communication, a third antenna 1030 that is pattern-printed and disposed outside the second antenna 1020 not to overlap the second antenna 1020 in order to perform second short-distance wireless communication, a first connection terminal 1040 for connection of opposite ends of a first connection pattern corresponding to the first antenna 1010 and opposite ends of a second connection pattern corresponding to the second antenna 1020, and a second connection terminal 1050 for connection of opposite ends of a third connection pattern corresponding to the third antenna 1030.

Here, the first connection terminal 1140 and the second connection terminal 1150 on the printed circuit board 1150. As such, the first connection pattern may not overlap the second antenna 1020 and the third antenna 1030 and, also, the second connection pattern may not overlap the third antenna 1130.

A connection pattern of each antenna may be formed as a lead wire that extends from opposite ends of a corresponding antenna or may be branched from a specific position of the corresponding antenna. Here, a connection pattern of each antenna and a position in which a connection terminal is disposed may be configured to minimize the length of the connection pattern.

For example, the first short-distance wireless communication may be magnetic secure transmission (MST) and the second short-distance wireless communication may be near field communication (NFC). Here, MST may be performed in a band of 3.24 MHz and NFC may be performed in a band of 13.56 MHz.

As another example, the first short-distance wireless communication may be near field communication (NFC) and the second short-distance wireless communication may be magnetic secure transmission (MST).

As another example, the first short-distance wireless communication and the second short-distance wireless communication may each correspond to any one of NFC, RFID communication, Bluetooth communication, ultra wideband (UWB) communication, MST communication, Apple pay communication, and Google pay communication.

FIG. 11 illustrates the case in which the second connection terminal 1150 is disposed at one side outside the third antenna 1130, this is merely an embodiment and, according to another embodiment, as shown in FIG. 12, the second connection terminal 1150 may be disposed between a second antenna 1220 and a third antenna 1230.

In particular, according to the embodiment shown in FIG. 12, a sufficient separation distance -e.g., 1 mm or greater- between the second antenna 1220 and the third antenna 1230 may be maintained and, thus, interference between corresponding antennas may be advantageously minimized. In addition, space utilization efficiency of a printed circuit board 1260 may be advantageously maximized.

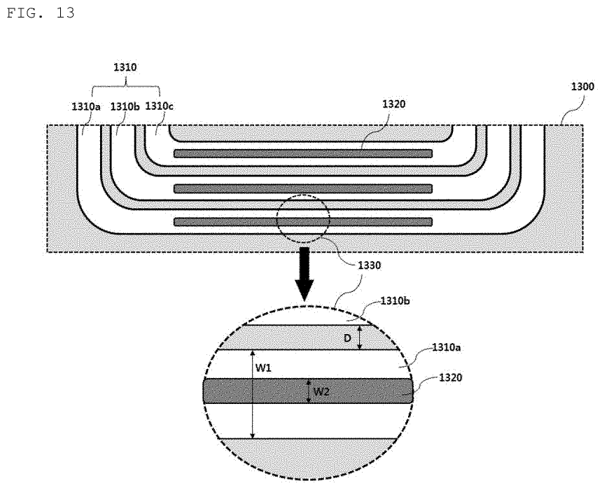

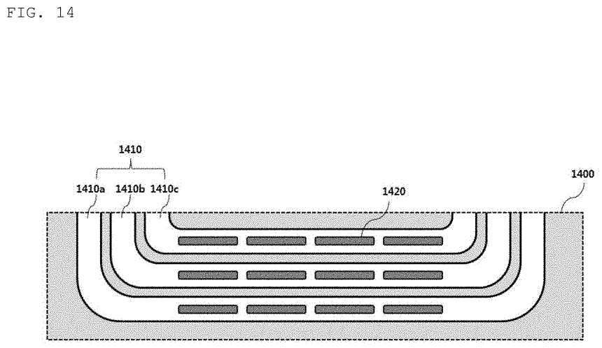

FIG. 13 is a diagram showing a structure of an antenna according to an embodiment.

Referring to FIG. 13, a portion of a structure of an antenna 1300 according to an embodiment is illustrated.

The antenna 1300 may be any one of the first antennas 310, 410, 510, 610, 1110, and 1210, the second antennas 320, 420, 520, 620, 1120, and 1220, and the third antennas 330, 430, 530, 630, 1130, and 1230 shown in FIGS. 3 to 6 and 9 and 10. Although a turn number of a coil included in the first to third antennas shown in FIGS. 3 to 6 and 9 to 10 is 12, 3, and 1 and a turn number of a coil included in the antenna 1300 shown in FIG.11 is 3, this is merely exemplary and the structure (i.e., a structure in which a coil has a slit) of the antenna 1300 may be applied to any one of the first to third antennas.

Assuming that the multi-mode antenna module shown in FIGS. 3 to 6 and 9 to 10 is installed in an electronic device with almost the same size and shape as the multi-mode antenna module, a case configuring an outer form of the electronic device may be coupled to an upper portion of the multi-mode antenna module. In this case, a section of the case may be thinned toward an edge from a central portion in order to enhance design and usability of the case and, accordingly, there may be a need for a design condition in which a thickness of the multi-mode antenna module is also thinned toward an edge from a central portion.

Accordingly, the first antenna and the second antenna that are positioned on the central portion of the multi-mode antenna module may be pattern-printed on opposite surfaces of the printed circuit board, respectively and, the corresponding antenna patterns printed on opposite surfaces may be connected to each other through a penetration hole (not shown) disposed in the printed circuit board. As such, resistance components of the first antenna and the second antenna may be reduced and, thus, reception sensitivity of the corresponding antenna may be enhanced.

However, the third antenna is positioned at the outermost portion of the multi-mode antenna module and, thus, it may be difficult to pattern-print the third antenna on the opposite surfaces of the printed circuit board and, the third antenna may be configured via pattern-print on only one surface of the printed circuit board. Accordingly, a resistance component of the third antenna is relatively high compared with the first antenna and the second antenna and, thus, reception sensitivity of the third antenna may be reduced and a recognition distance may be reduced.

The antenna 1300 shown in FIG. 13 may be configured to overcome this problem and may include a coil 1310 wound with a predetermined turn number and a slit 1320 disposed inside the coil 1310.

A turn number of the coil 1310 may be, for example, 3 in FIG. 13, and an outer coil 1310a, an intermediate coil 1310b, and an inner coil 1310c may be wound toward a central portion from an edge of the antenna 1300.

Each of the outer coil 1310a, the intermediate coil 1310b, and the inner coil 1310c may include the slit 1320. The slit 1320 may extend in a length direction of the coil 1310, and FIG. 13 illustrates the case in which the slit 1320 is disposed only on one side of the coil 1310 shaped in a straight line, according to another embodiment, the slit 1320 may also be disposed on an edge that extends over another side. In addition, the slit 1320 may be disposed in a length direction of each side (upper, lower, left, and right sides) of the multi-mode antenna module. In this case, the slit 1320 may be configured on an entire portion of the wound coil 1310.

The slit 1320 may be formed via an etching process on the pattern-printed coil 1310, and an internal portion of the slit 1320 may be empty and may be filled with an insulating material.

Although a partial region 1330 of the structure of the antenna 1300 is enlarged and illustrated in a lower part, structures of the coil 1310 and the slit 1320 are illustrated in detail as the partial region 1330.

An interval between the outer coil 1310a and the intermediate coil 1310b may be formed with about 0.3 mm or greater. A line width W1 of the outer coil 1310a may be formed with about 0.5 mm or greater and a line width W2 of the slit 1320 may be formed with about 0.1 mm or greater. This means that the line width W2 of the slit 1320 is about 20% or more of the line width W1 of the outer coil 1310a but, the scope of the present disclosure is not limited thereto.

The slit 1320 is disposed inside the outer coil 1310a and, thus, a line width of the outer coil 1310a may be materially reduced and, accordingly, whole resistance component of the coil 1310 may be lowered and reception sensitivity of the antenna 1300 may be enhanced.

According to another embodiment, line widths of slits that are respectively disposed in the outer coil 1310a, the intermediate coil 1310b, and the inner coil 1310c may be differently determined and, for example, the line width of the slit may be increased toward an outer side from an internal side.

FIG. 12 is a diagram showing a structure of an antenna according to another embodiment.

Referring to FIG. 12, a portion of a structure of an antenna 1400 according to another embodiment is illustrated.

The antenna 1400 is materially the same as the antenna 1300 shown in FIG. 11 unless mentioned otherwise and, thus, a repeated description thereof is omitted.

A coil 1410 included in the antenna 1400 may include an outer coil 1410a, an intermediate coil 1410b, and an inner coil 1410c.

Each of the outer coil 1410a, the intermediate coil 1410b, and the inner coil 1410c may include a slit 1420, and the slit 1420 of FIG. 12 may be disposed intermittently instead of continuously, differently from the slit 1320 of FIG. 11.

That is, the slit 1420 may be configured by continuously disposing a plurality of independent slits in a length direction of the coil 1410 and, the number of the independent slits is not limited to FIG. 12. However, the number of the independent slits may be determined consideration of convenience of a process.

The slit 1420 is disposed inside the outer coil 1410a, the intermediate coil 1410b, and the inner coil 1410c and, thus, line widths of the outer coil 1410a, the intermediate coil 1410b, and the inner coil 1410c may be materially reduced and, accordingly, whole resistance component of the coil 1410 may be lowered and reception sensitivity of the antenna 1400 may be enhanced.

According to another embodiment, line widths of slits that are respectively disposed in the outer coil 1410a, the intermediate coil 1410b, and the inner coil 1410c may be differently determined and, for example, the line width of the slit may be increased toward an outer side from an internal side.

FIG. 13 is a diagram showing a structure of an antenna according to another embodiment.

Referring to FIG. 13, a portion of a structure of an antenna 1500 according to another embodiment is illustrated.

The antenna 1500 is materially the same as the antenna 1300 shown in FIG. 13 unless mentioned otherwise and, thus, a repeated description thereof is omitted.

A coil 1510 included in the antenna 1500 may include an outer coil 1510a, an intermediate coil 1510b, and an inner coil 1510c.

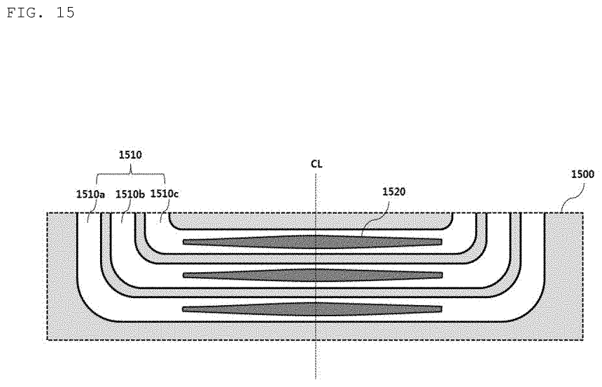

Each of the outer coil 1510a, the intermediate coil 1510b, and the inner coil 1510c may include a slit 1520, and the slit 1520 of FIG. 15 may have an irregular line width, differently from the slit 1320 of FIG. 13.

That is, the line width of the slit 1520 may be reduced toward an outer side based on a central line CL with respect to one side of the antenna 1500 but, this is merely exemplary and, the scope of the present disclosure is not limited thereto. For example, the line width of the slit 1520 may be increased toward an outer side based on the central line CL. This is because a line width of one side of the antenna 1500 is reduced toward an outer side based on the central line CL or is reduced toward the center from the outer side due to a restriction in design.

The slit 1520 may be disposed inside the outer coil 1510a, the intermediate coil 1510b, and the inner coil 1510c and, thus, line widths of the outer coil 1510a, the intermediate coil 1510b, and the inner coil 1510c may be materially reduced and, accordingly, whole resistance component of the coil 1510 may be lowered and reception sensitivity of the antenna 1500 may be enhanced.

According to another embodiment, the outer coil 1510a, an average line width of the slits respectively disposed on the intermediate coil 1510b and the inner coil 1510c may be differently determined and, for example, the average line width of the slits may be increased toward an outer side from an inner side.

According to another embodiment, the slits respectively disposed on the outer coil 1510a, the intermediate coil 1510b, and the inner coil 1510c may be disposed intermittently instead of continuously.

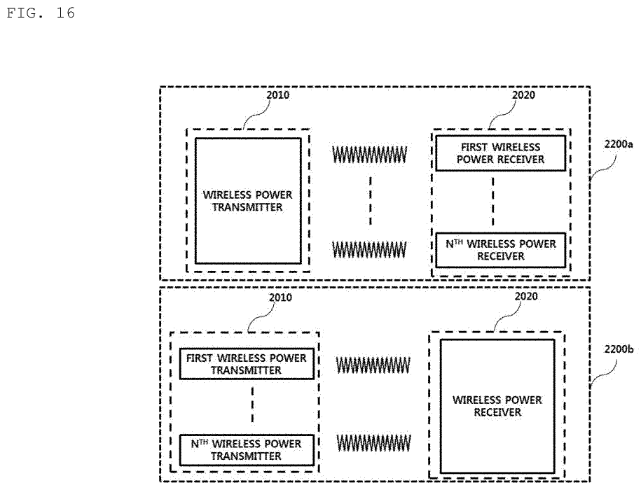

FIG. 16 is a block diagram for explanation of a wireless charging system according to another embodiment.

For example, as shown in a reference numeral 2200a, the wireless power receiver 2020 may include a plurality of wireless power reception devices, and the plurality of wireless power reception devices may be connected to one wireless power transmitter 2010 to perform wireless charging. In this case, the wireless power transmitter 2010 may distribute and transmit power to the plurality of wireless power reception devices using a time-division method without being limited thereto, and as another example, the wireless power transmitter 2010 may distribute and transmit power to a plurality of wireless power reception devices using different frequency bands allocated to respective wireless power reception devices.

In this case, the number of wireless power reception devices connectable to one wireless power transmitter 2010 may be adaptively determined based on at least one of requested electric energy for respective wireless power reception devices, a battery charging state, power consumption of an electronic device, and available electric energy of a wireless power transmission device.

As another example, as shown in a reference numeral 2200b, the wireless power transmitter 2010 may include a plurality of wireless power transmission devices. In this case, the wireless power receiver 2020 may be simultaneously connected to the plurality of wireless power transmission devices, and may simultaneously receive power from the connected wireless power transmission devices to perform charging. In this case, the number of wireless power reception devices connectable to the wireless power receiver 2020 may be adaptively determined based on requested electric energy of the wireless power receiver 2020, a battery charging state, power consumption of an electronic device, available electric energy of a wireless power transmission device, and so on.

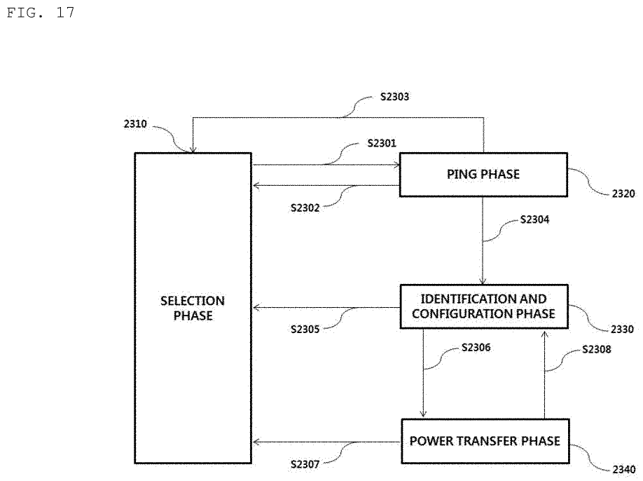

FIG. 17 is a state transition diagram for explanation of a wireless power transmission procedure defined in the wireless power consortium (WPC) standard.

Referring to FIG. 17, power transmission to a receiver from a transmitter according to the WPC standard may be broadly classified into a selection phase 2310, a ping phase 2320, an identification and configuration phase 2330, and a power transfer phase 2340.

The selection phase 2310 may be a phase that transitions when a specific error or a specific event is detected while power transmissions is started or power transmission is maintained. Here, the specific error and the specific event would be obvious from the following description. In addition, in the selection phase 2310, the transmitter may monitor whether an object is present on an interface surface. Upon detecting that the object is present on the interface surface, the transmitter may transition to the ping phase 2320 (S2301). In the selection phase 2310, the transmitter may transmit an analog ping signal with a very short pulse and may detect whether an object is present in an activate area of the interface surface based on a current change of a transmission coil.

In the ping phase 2320, upon detecting the object, the transmitter may activate the receiver and may transmit a digital ping for identifying whether the receiver is compatible with the WPC standard. In the ping phase 2320, when the transmitter does not receive a response signal to the digital ping, e.g., a signal strength indicator from the receiver, the ping phase 2320 may re-transition to the selection phase 2310 (S2302). In the ping phase 2320, upon receiving a signal indicating that power transmission is completed, i.e., an end of power signal, from the receiver, the transmitter may transition to the selection phase 2310 (S2303).

When the ping phase 2320 is completed, the transmitter may transition to the identification and configuration phase 2330 for collecting receiver identification and receiver configuration and state information (S2304).

In the identification and configuration phase 2330, when the transmitter receives an unexpected packet or does not receive an expected packet for a predefined time period (time out), there is packet transmission error, or power transfer contract is not set, the transmitter may transition to the selection phase 310 (S305).

When identification and configuration of the receiver are completed, the transmitter may transition to the power transfer phase 2340 for wirelessly transmitting power (S2306).

In the power transfer phase 2340, when the transmitter receives an unexpected packet or does not receive an expected packet for a predefined time period (time out), preset power transfer contract violation occurs, or charging is completed, the transmitter may transition to the selection phase 2310 (S2307).

In the power transfer phase 2340, when power transfer contract needs to be re-configured depending on a state change in the transmitter, the transmitter may transition to the identification and configuration phase 2330 (S2308).

The power transfer contract may be set based on state and characteristics information of the transmitter and the receiver. For example, the state information of the transmitter may include information on a maximum transmissible power amount, information on the number of maximum acceptable receivers, and so on and the state information of the receiver may include information on required power, and so on.

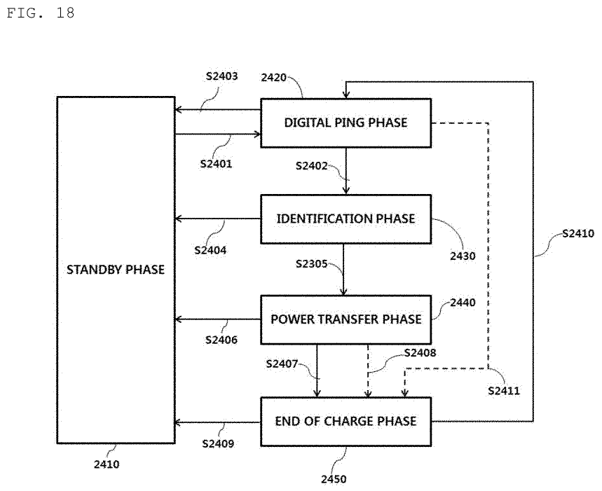

FIG. 18 is a state transition diagram for explanation of a wireless power transmission procedure defined in the power matters alliance (PMA) standard.

Referring to FIG. 18, power transmission to a receiver from a transmitter according to the PMA standard may be broadly classified into a standby phase 2410, a digital ping phase 2420, an identification phase 2430, a power transfer phase 2440, and an end of charge phase 2450.

The standby phase 2410 may be a phase that transitions when a specific error or a specific event is detected while a receiver identification procedure for power transmission is performed or power transmission is maintained. Here, the specific error and the specific event would be obvious from the following description. In addition, in the standby phase 2410, the transmitter may monitor whether an object is present on a charging surface. When the transmitter detects that the object is present on the charging surface or is performing RXID reattempt, the standby phase 2410 may transition to the digital ping phase 2420 (S2401). Here, RXID refers to a unique identifier (ID) allocated to a PMA compatible receiver. In the standby phase 2410, the transmitter may transmit an analog ping with a very short pulse and may detect whether an object is present in an active area of an interface surface, e.g., a charging bed based on a current change of a transmission coil.

The transmitter that transitions to the digital ping phase 2420 may emit a digital ping signal for identifying whether the detected object is a PMA compatible receiver. When sufficient power is supplied to a receiver according to the digital ping signal transmitted by the transmitter, the receiver may modulate the received digital ping signal according to a PMA communication protocol to transmit a predetermined response signal to a transmitter. Here, the response signal may include a signal strength indicator indicating intensity of power received by the receiver. In the digital ping phase 2420, upon receiving an effective response signal, the receiver may transition to the identification phase 2430 (S2402).

When, in the digital ping phase 2420, the transmitter does not receive the response signal or the corresponding receiver is not a PMA compatible receiver, i.e., in the case of foreign object detection (FOD), the transmitter may transition to the standby phase 2410 (S2403). For example, a foreign object (FO) may be a metallic object including a coin, a key, or the like.

In the identification phase 2430, when the transmitter fails in a receiver identification procedure or needs to re-perform the receiver identification procedure and does not complete the receiver identification procedure within a predefined time period, the transmitter may transition to the standby phase 2410 (S2404).

Upon succeeding in receiver identification, the transmitter may transition to the power transfer phase 2440 from the identification phase 2430 (S2405).

In the power transfer phase 2440, when the transmitter does not receive a desired signal within a predetermined time period (Time Out) or detects an FO, or a voltage of a reception coil is greater than a predefined reference value, the transmitter may transition to the standby phase 2410 (S2406).

In the power transfer phase 2440, when temperature detected by a temperature sensor included in the transmitter is greater than a predetermined reference value, the transmitter may transition to 2450 (S2407).

In the end of charge end 2450, upon checking that the receiver is removed from the charging surface, the transmitter may transition to the standby phase 2410 (S2409).

In an over-temperature state, when measured temperature is lowered to a reference value or less after a predetermined time period elapses, the transmitter may transition to the digital ping phase 2420 from the end of charge end 2450 (S2410).

In the digital ping phase 2420 or the power transfer phase 2440, upon receiving an end of charge (EOC) request, the transmitter may transition to the end of charge end 2450 (S2408 and S2411).

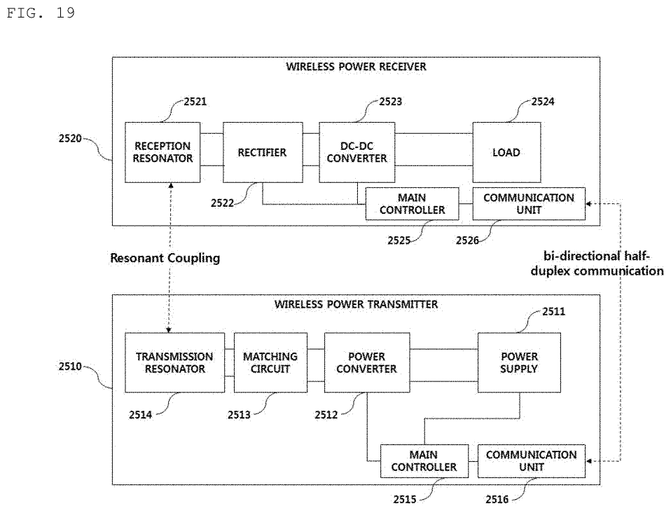

FIG. 19 is a block diagram for explanation of a structure of a wireless power transmission system according to an embodiment.

Referring to FIG. 19, the wireless power transmission system may include 2510 and a wireless power receiver 2520.

Although FIG. 19 illustrates the case in which the wireless power transmitter 2510 wirelessly transmits power to one wireless power receiver 2520, this is merely an embodiment and, thus, according to another embodiment, the wireless power transmitter 2510 may wirelessly transmit power to a plurality of wireless power receivers 2520. It is noted that, according to another embodiment, the wireless power receiver 2520 may wirelessly and simultaneously receive power from a plurality of wireless power transmitters 2510.

The wireless power transmitter 2510 may generate a magnetic field using a specific power transmission frequency and transmit power to the wireless power receiver 2520.

The wireless power receiver 2520 may receive power in synchronization with the same frequency as a frequency used by the wireless power transmitter 2510.

For example, a frequency used for power transmission may be a band of 6.78 MHz, without being limited thereto.

That is, power transmitted by the wireless power transmitter 2510 may be transmitted to the wireless power receiver 2520 that resonates with the wireless power transmitter 2510.

A maximum number of wireless power receivers 2520 capable of receiving power from one wireless power transmitter 2510 may be determined based on a maximum transmission power level of the wireless power transmitter 2510, a maximum power reception level of the wireless power receiver 2520, and physical structures of the wireless power transmitter 2510 and the wireless power receiver 2520.

The wireless power transmitter 2510 and the wireless power receiver 2520 may perform bi-directional communication with a different frequency band from a frequency for wireless power transmission, i.e. a resonance frequency band. For example, the bi-directional communication may use a half-duplex Bluetooth low energy (BLE) communication protocol.

The wireless power transmitter 2510 and the wireless power receiver 2520 may exchange each other's characteristics and state information, i.e. power negotiation information through the bi-directional communication.

For example, the wireless power receiver 2520 may transmit predetermined power reception state information for controlling a level of power received from the wireless power transmitter 2510 to the wireless power transmitter 2510 through bi-directional communication, and the wireless power transmitter 2510 may dynamically control a transmitted power level based on the received power reception state information. As such, the wireless power transmitter 2510 may optimize power transmission efficiency and may also perform a function of preventing a load from being damaged due to over voltage, a function of preventing unnecessary power from being wasted due to under voltage, and so on.

The wireless power transmitter 2510 may perform a function of authenticating and identifying the wireless power receiver 2520 through bi-directional communication, a function of identifying an incompatible apparatus or a non-rechargeable object, a function for identifying a valid load, and so on.

Hereinafter, a wireless power transmission procedure of a resonance mode will be described in more detail with reference to FIG. 19.

The wireless power transmitter 2510 may include a power supply 2511, a power converter 2512, a matching circuit 2513, a transmission resonator 2514, a main controller 2515, and a communication unit 2516. The communication unit 2516 may include a data transmitter and a data receiver.

The power supply 511 may apply a specific voltage to the power converter 2512 under control of the main controller 2515. In this case, the applied voltage may be a DC voltage or an AC voltage.

The power converter 2521 may convert a voltage received from the power supply 2511 into a specific voltage under control of the main controller 2515. To this end, the power converter 2521 may include at least one of a DC/DC convertor, an AC/DC convertor, and a power amplifier.

The matching circuit 2513 may be a circuit for matching impedance between the power converter 2521 and the transmission resonator 514 in order to maximize power transmission efficiency.

The transmission resonator 514 may wirelessly transmit power using a specific resonance frequency according to a voltage applied from the matching circuit 2513.

The wireless power receiver 2520 may include a reception resonator 2521, a rectifier 2522, a DC-DC converter 2523, a load 2524, a main controller 2525, and a communication unit 2526. The communication unit 2526 may include a data transmitter and a data receiver.

The reception resonator 2521 may receive power transmitted by the transmission resonator 514 through a resonance phenomenon.

The rectifier 521 may perform a function of converting an AC voltage applied from the reception resonator 2521 into a DC voltage.

The DC-DC converter 2523 may convert the rectified DC voltage into a specific DC voltage required by the load 2524.

The load 2524 may be an internal battery of a terminal including a wireless power receiver. The internal battery may store power in a battery with a specific DC voltage output from the DC-DC converter 2523 as an input voltage.

The main controller 2525 may control operations of the rectifier 2522 and the DC-DC converter 2523 or may generate the characteristics and state information of the wireless power receiver 2520 and may control the communication unit 2526 to transmit the characteristics and state information of the wireless power receiver 2520 to the wireless power transmitter 2510. For example, the main controller 2525 may monitor output voltages and current intensity of the rectifier 2522 and the DC-DC converter 2523 and control operations of the rectifier 2522 and the DC-DC converter 2523.

Information on the monitored output voltages and current intensity may be transmitted to the wireless power transmitter 2510 through the communication unit 2526 in real time.

The main controller 2525 may compare the rectified DC voltage with a predetermined reference voltage to determine whether a current state is an over-voltage state or an under-voltage state, and upon detecting a system error state as the determination result, the main controller 2525 may transmit the detection result to the wireless power transmitter 2510 through the communication unit 2526.

Upon detecting a system error state, the main controller 2525 may control operations of the rectifier 2522 and the DC-DC converter 2523 or control power supplied to the load 2524 using a predetermined over current cutoff circuit including a switch and/or a Zener diode in order to prevent a load from being damaged.

Although FIG. 19 illustrates the case in which the main controller 2515 or 2525 and the communication unit 2516 or 2526 are configured as different modules, this is merely an embodiment and, thus, according to another embodiment, it is noted that the main controller 2515 or 2525 and the communication unit 2516 or 2526 may be configured as one module.

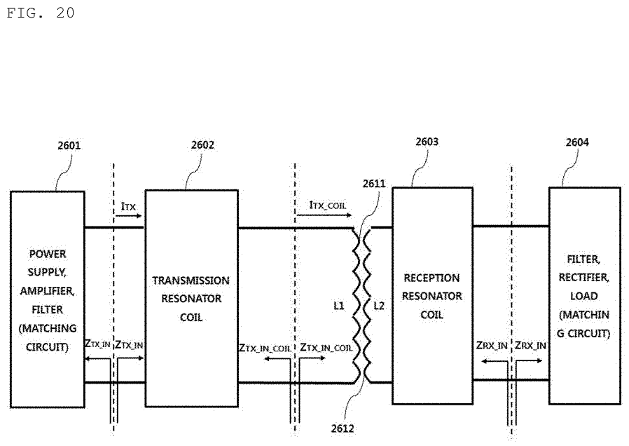

FIG. 20 is an equivalent circuit diagram of a wireless power transmission system according to an embodiment.

In detail, FIG. 20 illustrates an interface point in an equivalent circuit for measuring reference parameters to be described below.

Hereinafter, the meaning of reference parameters illustrated in FIG. 20 will be described briefly.

I_{TX} and I_{TX_COIL} may refer to root mean square (RMS) current supplied to a matching circuit (or matching network) 2601 of the wireless power transmitter and RMS current supplied to a transmission resonator coil 2602 of the wireless power transmitter, respectively.

Z_{RX_IN} and Z_{TX_IN_COIL} may refer to input impedance of a front end of the matching circuit 2601 of the wireless power transmitter and input impedance of a rear end of the matching circuit 2601 and a front end of the transmission resonator coil 2602, respectively.

L1 and L2 may refer to an inductance value of the transmission resonator coil 2602 and an inductance value of a reception resonator coil 2603, respectively.

Z_{RX_IN} may refer to input impedance of a rear end of a matching circuit 2604 of a wireless power receiver and a front end of a filter/rectifier/load 2605.

According to an embodiment, a resonance frequency used in an operation of a wireless power transmission system may be 6.78 MHz±15 kHz.

In addition, a wireless power transmission system according to an embodiment may provide simultaneous charging, i.e. multi-charging, to a plurality of wireless power receivers, and in this case, even if a new wireless power receiver is added or a wireless power receiver is removed, a reception power variation amount of a maintained wireless power receiver may be controlled not to exceed a predetermined reference value or more. For example, a reception power variation amount may be, without being limited to, ±10%.

According to a condition for maintaining the reception power variation amount, a wireless power receiver that is added to a charging area or is removed may not overlap an existing wireless power receiver.

When the matching circuit 2604 of the wireless power receiver is connected to a rectifier, a real part of Z_{TX_IN} may have an inverse relationship with load resistance of a rectifier (hereinafter, referred to as R_{RECT}). That is, increase in R_{RECT} may reduce Z_{TX_IN} and reduction in R_{RECT} may increase Z_{TX_IN}.

According to the present disclosure, resonator coupling efficiency may be a maximum power reception ratio calculated by dividing power transmitted to the load 2604 from a reception resonator coil by power carried in a resonance frequency band by the transmission resonator coil 2602. Resonator coupling efficiency between the wireless power transmitter and the wireless power receiver may be calculated when reference port impedance Z_{TX_IN} of a transmission resonator and a reference port impedance Z_{RX_IN} of a reception resonator are completely matched with each other.

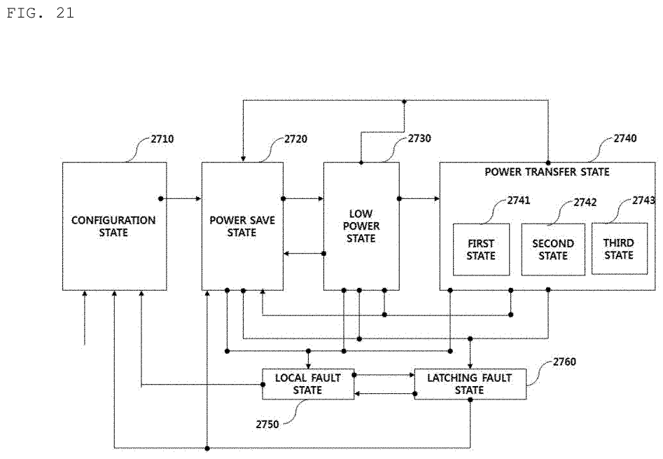

FIG. 21 is a state transition diagram for explanation of a state transition procedure of a wireless power transmitter using an electromagnetic resonance mode according to an embodiment.

Referring to FIG. 21, a state of the wireless power transmitter may roughly include a configuration state 2710, a power save state 2720, a low power state 2730, a power transfer state 2740, a local fault state 2750, and a latching fault state 2760.

When power is supplied to a wireless power transmitter, the wireless power transmitter may transition to the configuration state 2710. The wireless power transmitter may transition to the power save state 2720 when a predetermined reset timer expires or an initialization procedure is completed in the configuration state 2710.

In the power save state 2720, the wireless power transmitter may generate a beacon sequence and transmit the beacon sequence through a resonance frequency band.

Here, the wireless power transmitter may perform control to enter the power save state 2720 and to initiate the beacon sequence within a predetermined time. For example, the wireless power transmitter may perform control to initialize the beacon sequence within 50 ms after transition to the power save state 2720, without being limited thereto.

In the power save state 2720, the wireless power transmitter may periodically generate and transmit a first beacon sequence for detection of the wireless power receiver and may detect impedance variation of a reception resonator, i.e. load variation. Hereinafter, for convenience of description, a first beacon and a first beacon sequence will be referred to as a short beacon or a short beacon sequence, respectively.

In particular, the short beacon sequence may be repeatedly generated and transmitted with a predetermined time interval t_{CYCLE} for a short period t_{SHORT_BEACON} so as to save standby power of the wireless power transmitter before the wireless power receiver is detected. For example, t_{SHORT_BEACON} may be set to 30 ms or less and t_{CYCLE} may be set to 250 ms±5 ms. In addition, current intensity of a short beacon may be a predetermined reference value or more and may be gradually increased for a predetermined time. For example, minimum current intensity of a short beacon may be set to be sufficiently high so as to detect a wireless power receiver of Category 2 or more of Table 2 above.

According to the present disclosure, a wireless power transmitter may include a predetermined sensing element for detection of change in reactance and resistance by a reception resonator according to a short beacon.

In addition, in the power save state 2720, the wireless power transmitter may periodically generate and transmit a second beacon sequence for supplying sufficient power required for booting and response of the wireless power receiver. Hereafter, for convenience of description, the second beacon and the second beacon sequence will be referred to as a long beacon and a long beacon sequence, respectively.

That is, when booting is completed through a second beacon sequence, the wireless power receiver may broadcast a predetermined response signal through an out-of-band communication channel.

In particular, the long beacon sequence may be generated and transmitted with a predetermined time interval t_{LONG_BEACON_PERIOD} for a relatively long period compared with a short beacon sequence in order to supply sufficient power required for booting of the wireless power receiver. For example, t_{LONG_BEACON} may be set to 105 ms+5 ms, t_{LONG_BEACON_PERIOD} may be set to 850 ms, and current intensity of a long beacon may be relatively high compared with current intensify of the short beacon. In addition, the long beacon may be maintained with power of predetermined intensity during a transmission period.

Then, the wireless power transmitter may be on standby to receive a predetermined response signal during a transmission period of the long beacon after detecting change in impedance of a reception resonator. Hereinafter, for convenience of description, the response signal will be referred to as an advertisement signal. Here, the wireless power receiver may broadcast the advertisement signal through a different out-of-band communication frequency band from a resonance frequency band.

For example, the advertisement signal may include at least one or any one of message identification information for identifying a message defined in a corresponding out-of-band communication standard, unique service or wireless power receiver identification information for identifying whether a wireless power receiver is a proper receiver or a compatible receiver to a corresponding wireless power transmitter, output power information of a wireless power receiver, information on rated voltage/current applied to a load, antenna gain information of a wireless power receiver, information for identifying a category of a wireless power receiver, authentication information of a wireless power receiver, information on whether an over voltage protection function is installed, and version information of software installed in a wireless power receiver.

Upon receiving an advertisement signal, the wireless power transmitter may transition to the low power state 2730 from the power save state 2720 and, then, may establish an out-of-band communication link with a wireless power receiver. Continuously, the wireless power transmitter may perform a registration procedure to a wireless power receiver through the established out-of-band communication link. For example, when out-of-band communication is Bluetooth low-power communication, the wireless power transmitter may perform Bluetooth pairing with the wireless power receiver and the transmitter and the receiver exchange at least one of state information, characteristics information, and control information with each other through the paired Bluetooth link.

When the wireless power transmitter transmits a predetermined control signal, i.e. a predetermined control signal for requesting a wireless power receiver to transmit power to a load, for initializing charging through out-of-band communication in the low power state 2730 to the wireless power receiver, the wireless power transmitter may transition to the power transfer state 2740 from the low power state 2730.

When an out-of-band communication link establishment procedure or registration procedure is not normally completed in the low power state 2730, the wireless power transmitter may transition to the power save state 2720 from the low power state 2730.

The wireless power transmitter may drive a separately divided link expiration timer for connection with each wireless power receiver and the wireless power receiver needs to transmit a predetermined message indicating that the receiver is present to the wireless power transmitter with a predetermined time before the link expiration timer expires. The link expiration timer may be reset whenever the message is received and an out-of-band communication link established between the wireless power receiver and the wireless power receiver may be maintained when the link expiration timer does not expire.

When all link expiration timers corresponding to out-of-band communication links established between a wireless power transmitter and at least one wireless power receiver expire in the low power state 2730 or the power transfer state 2740, the wireless power transmitter may transition to the power save state 2720.

Upon receiving a valid advertisement signal from the wireless power receiver, the wireless power transmitter in the low power state 2730 may drive a predetermined registration timer. In this case, when a registration timer expires, a wireless power transmitter in the low power state 2730 may transition to the power save state 2720. In this case, the wireless power transmitter may output a predetermined notification signal indicating registration failure through a notification display element, e.g. including an LED lamp, a display screen, and a beeper, included in the wireless power transmitter.

When all connected wireless power receivers are completely charged in the power transfer state 2740, the wireless power transmitter may transition to the low power state 2730.

In particular, the wireless power receiver may permit registration of a new wireless power receiver in the remaining states except for the configuration state 2710, the local fault state 2750, and the latching fault state 2760.

In addition, the wireless power transmitter may dynamically control transmitted power based on state information received from the wireless power receiver in the power transfer state 2740.

In this case, receiver state information transmitted to the wireless power transmitter from the wireless power receiver may include at least one of required power information, information on voltage and/or current measured at a rear end of a rectifier, charging state information, information for announcing over current, over voltage, and/or overheating states, and information indicating whether an element for shutting off or reducing power transmitted to a load is activated according to over current or over voltage. In this case, the receiver state information may be transmitted at a predetermined period or may be transmitted whenever a specific event occurs. In addition, the element for shutting off or reducing power transmitted to a load according over current or over voltage may be provided using at least one of an ON/OFF switch and a Zener diode.

According to another embodiment, the receiver state information transmitted to the wireless power transmitter from the wireless power receiver may further include at least one of information indicating that external power is connected to the wireless power receiver by wire and information indicating that an out-of-band communication mode is changed, e.g. near field communication (NFC) may be changed to Bluetooth low energy (BLE) communication.

According to another embodiment, a wireless power transmitter may adaptively determine intensity of power to be received for each wireless power receiver based on at least one of current available power of the wireless power transmitter, priority for each wireless power receiver, and the number of connected wireless power receivers. Here, the intensity of power to be transmitted for each wireless power receiver may be determined as a ratio for receiving power based on maximum power to be processed by a rectifier of a corresponding wireless power receiver.

Then, the wireless power transmitter may transmit a predetermined power adjustment command containing information on the determined power intensity to the corresponding wireless power receiver. In this case, the wireless power receiver may determine whether power is capable of being controlled in the power intensity determined by the wireless power transmitter and may transmit the determination result to the wireless power transmitter through a predetermined power adjustment response message.

According to another embodiment, the wireless power receiver may transmit predetermined receiver state information indicating whether wireless power adjustment is possible according to the power adjustment command of the wireless power transmitter prior to reception of the power adjustment command

The power transfer state 2740 may be any one of a first state 2741, a second state 2742, and a third state 2743 according to a power reception state of a connected wireless power receiver.

For example, the first state 2741 may refer to a state in which power reception states of all wireless power receivers connected to the wireless power transmitter are each a normal voltage state.

The second state 2742 may refer to a state in which a power reception state of at least one wireless power receiver connected to the wireless power transmitter is a low voltage state and a wireless power receiver of a high voltage state is not present.

The third state 2743 may refer to a state in which a power reception state of at least one wireless power receiver connected to the wireless power transmitter is a high voltage state.

Upon detecting system error in the power save state 2720, the low power state 2730, or the power transfer state 2740, the wireless power transmitter may transition to the latching fault state 2760.

Upon determining that all connected wireless power receivers are removed from a charging region, the wireless power transmitter in the latching fault state 2760 may transition to the configuration state 2710 or the power save state 2720.

In addition, upon detecting local fault in the latching fault state 2760, the wireless power transmitter may transition to the local fault state 2750. Here, when local fault is released, the wireless power transmitter in the local fault state 2750 may re-transition to the latching fault state 2760.

On the other hand, when the wireless power transmitter transitions to the local fault state 2750 from any one of the configuration state 2710, the power save state 2720, the low power state 2730, and the power transfer state 2740, if local fault is released, the wireless power transmitter may transition to the configuration state 2710.

When the wireless power transmitter transitions to the local fault state 2750, power supplied to the wireless power transmitter may be shut off. For example, upon detecting fault such as over voltage, over current, and overheating, the wireless power transmitter may transition to the local fault state 2750, without being limited thereto.

For example, upon detecting over voltage, over current, overheating, or the like, the wireless power transmitter may transmit a predetermined power adjustment command for reducing intensity of power received by the wireless power receiver to at least one connected wireless power receiver.

As another example, upon detecting over voltage, over current, overheating, or the like, the wireless power transmitter may transmit a predetermined control command for stopping charging of the wireless power receiver to at least one connected wireless power receiver.

Through the aforementioned power adjustment procedure, the wireless power transmitter may prevent a device from being damaged due to over voltage, over current, overheating, or the like.

When intensity of output current of a transmission resonator is a reference value or more, the wireless power transmitter may transition to the latching fault state 2760. In this case, the wireless power transmitter having transitioned to the latching fault state 2760 may attempt to adjust the intensity of the output current of the transmission resonator to a reference value or less for a predetermined time. Here, the attempt may be repeatedly performed a predetermined number of times. Despite repeated performance, when the latching fault state 2760 is not released, the wireless power transmitter may transmit a predetermined notification signal indicating that the latching fault state 2760 is not released, to a user using a predetermined notification element. In this case, when all wireless power receivers positioned in the charging region of the wireless power transmitter are removed by the user, the latching fault state 2760 may be released.

On the other hand, when intensity of output current of a transmission resonator is reduced to a reference value or less within a predetermined time or the intensity of output current of the transmission resonator is reduced to a reference value or less during the predetermined repeated performance, the latching fault state 2760 may be automatically released, and in this case, the wireless power transmitter may automatically transition to the power save state 2720 from the latching fault state 2760 and may re-perform detection and identification procedures on the wireless power receiver.

The wireless power transmitter in the power transfer state 2740 may transmit consecutive power and may adaptively control the transmitted power based on state information of the wireless power receiver and a predefined optimal voltage region setting parameter.

For example, the optimal voltage region setting parameter may include at least one of a parameter for identifying a low voltage region, a parameter for identifying an optimal voltage region, a parameter for identifying a high voltage region, and a parameter for identifying an over voltage region.

When a power reception state of the wireless power receiver is in a low voltage region, the wireless power transmitter may increase transmitted power, and when the power reception state is in a high voltage region, the wireless power transmitter may reduce transmitted power.

The wireless power transmitter may control transmitted power to maximize power transmission efficiency.

The wireless power transmitter may control transmitted power such that a deviation of a power amount required by the wireless power receiver is a reference value or less.

In addition, when an output voltage of a rectifier of a wireless power receiver reaches a predetermined over voltage region, i.e. when an over voltage is detected, the wireless power transmitter may stop power transmission.

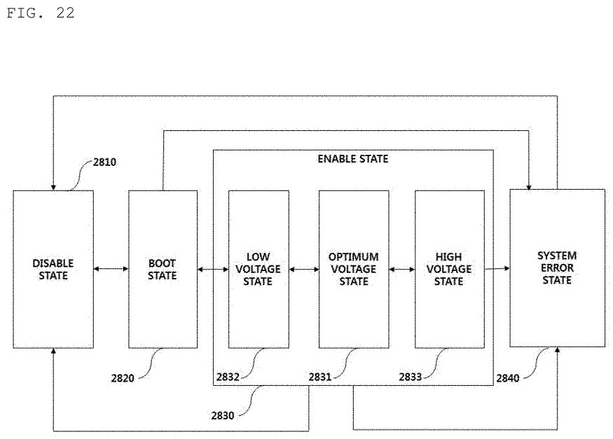

FIG. 22 is a state transition diagram of a wireless power receiver using an electromagnetic resonance mode according to an embodiment.

Referring to FIG. 22, a state of the wireless power receiver may largely include a disable state 2810, a boot state 2820, an enable state 2830 (or an on state), and a system error state 2840.

In this case, the state of the wireless power receiver may be determined based on intensity (hereinafter, for convenience of description, referred to as V_{VECT}) of an output voltage at an end of a rectifier of the wireless power receiver.

The enable state 2830 may be divided into an optimum voltage state 2831, a low voltage state 2832, and a high voltage state 2833 according to a value of V_{RECT}.

When a measured value of V_{RECT} is equal to or greater than a predetermined value of V_{RECT_BOOT}, the wireless power receiver in the disable state 2810 may transition to the boot state 2820.

In the boot state 2820, the wireless power receiver may establish an out-of-band communication link with the wireless power transmitter and may stand by until a value of V_{RECT} reaches power required at an end of a load.

Upon checking that the value of V_{RECT} reaches power required at the end of the load, the wireless power receiver in the boot state 2820 may transition to the enable state 2830 and may begin charging.

Upon checking that charging is completed or stopped, the wireless power receiver in the enable state 2830 may transition to the boot state 2820.

Upon detecting predetermined system error, the wireless power receiver in the enable state 2830 may transition to the system error state 2840. Here, the system error may include other predefined system error conditions as well as over voltage, over current, and overheating.

When a value of V_{RECT} is reduced to a value of V_{RECT_BOOT} or less, the wireless power receiver in the enable state 2830 may transition to the disable state 2810.

In addition, when a value of V_{RECT} is reduced to a value of V_{RECT_BOOT} or less, the wireless power receiver in the boot state 2820 or the system error state 2840 may transition to the disable state 2810.

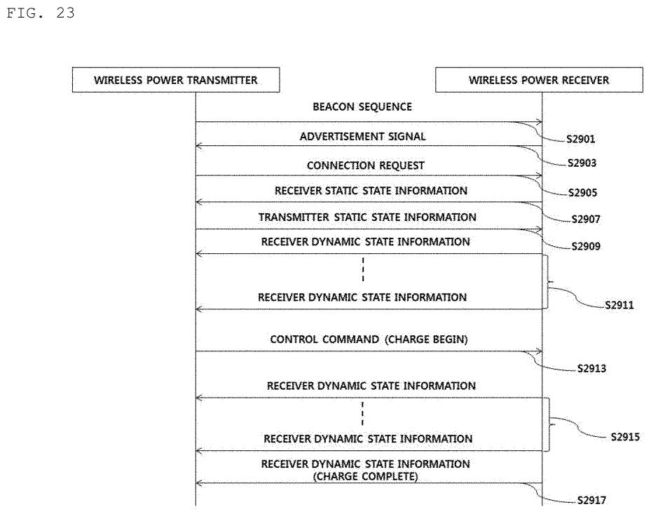

FIG. 23 is a flowchart for explanation of a wireless charging procedure using an electromagnetic resonance mode according to an embodiment.

Referring to FIG. 23, when configuration of the wireless power transmitter, i.e., booting is completed according to power supply, the wireless power transmitter may generate a beacon sequence and transmit the beacon sequence through a transmission resonator (S2901).

Upon detecting the beacon sequence, the wireless power receiver may broadcast an advertisement signal containing identification information and characteristics information of the wireless power receiver (S2903). In this case, it is noted that the advertisement signal may be repeatedly transmitted at a predetermined period until a connection request signal to be described later is received from the wireless power transmitter.

Upon receiving an advertisement signal, the wireless power transmitter may transmit a predetermined connection request signal for establishment of an out-of-band communication link to the wireless power receiver (S2905).

Upon receiving the connection request signal, the wireless power receiver may establish the out-of-band communication link and transmit static state information of the wireless power receiver through the established out-of-band communication link (S2907).

Here, the static state information of the wireless power receiver may include at least one of category information, hardware and software version information, maximum rectifier output power information, initial reference parameter information for power adjustment, information on required voltage or power, information for identifying whether a power adjustment function is installed, information on a supportable out-of-band communication mode, information on a supportable power control algorithm, and information on an initially set voltage value of an end of a preferred rectifier in a wireless power receiver.

Upon receiving the static state information of the wireless power receiver, the wireless power transmitter may transmit the static state information of the wireless power transmitter to the wireless power receiver through the out-of-band communication link (S2909).

Here, the static state information of the wireless power transmitter may include at least one of transmitter power information, class information, hardware and software version information, information on a maximum number of supportable wireless power receivers, and/or a number of currently connected wireless power receivers.

Then, the wireless power receiver may monitor power reception state and charging state of the wireless power receiver in real time and may transmit dynamic state information to the wireless power transmitter periodically or when a specific event occurs (S2911).

Here, the dynamic state information of the wireless power receiver may include at least one of information on output voltage and current of a rectifier, information on voltage and current applied to a load, information on an internally measured temperature of the wireless power receiver, reference parameter variation information (a minimum rectifying voltage value, a maximum rectifying voltage value, and initially set variation value in voltage at an end of a preferred rectifier) for power adjustment, charging state information, system error information, and alert information. The wireless power transmitter may change a setting value contained in existing static state information upon receiving the reference parameter variation information for power adjustment and perform power adjustment.

Upon preparing a sufficient amount of power for charging the wireless power receiver, the wireless power transmitter may transmit a predetermined control command through an out-of-band communication link and control the wireless power receiver to initiate charging (S2913).

Then, the wireless power transmitter may receive dynamic state information from the wireless power receiver and may dynamically control transmitted power (S2915).

When internal system error is detected or charging is completed, the wireless power receiver may add data for identifying corresponding system error and/or data indicating that charging is completed to the dynamic state information and transmit the information to the wireless power transmitter (S2917). Here, the system error may include over current, over voltage, overheating, etc.

For example, an out-of-band communication mode applicable to embodiments of the present disclosure may include at least one of near field communication (NFC), radio frequency identification (RFID) communication, Bluetooth low energy (BLE) communication, wideband code division multiple access (WCDMA) communication, long term evolution (LTE)/LTE-advance communication, and Wi-Fi communication

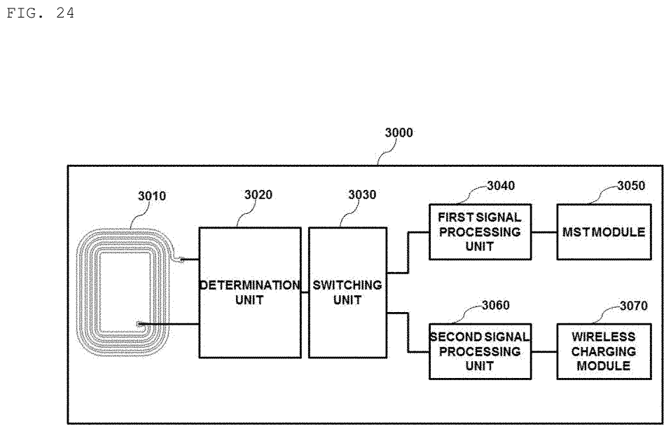

FIG. 24 is a structure diagram for explanation of a wireless power receiver including an antenna for combined use of magnetic security transmission (MST) and wireless power transmission (WPT) according to an embodiment.

Referring to FIG. 24, a wireless power receiver 3000 may include an antenna for combined use of magnetic secure transmission (MST) and wireless power transmission (WPT) 3010, a determination unit 3020, a switching unit 3030, a first signal processing unit 3040, an MST module 3050, a second signal processing unit 3060, and a wireless charging module 3070. Components shown in FIG. 24 are not necessary components and, thus, greater or fewer components than in FIG. 24 may constitute the wireless power receiver.

The antenna for combined use of magnetic secure transmission (MST) and wireless power transmission (WPT) 3010 (hereinafter, the antenna for combined use 3010) may transmit and receive a radio signal. A radio signal may be a magnetic signal generated by the antenna for combined use 3010.

Depending on the cases, the antenna for combined use 3010 may transmit and receive a magnetic signal but, the magnetic signal may include only any one of MST payment information and a wireless power signal.

When receiving a magnetic signal including MST payment information, the wireless power receiver 3000 may be operated in a magnetic security transmission (MST) mode and, when receiving a magnetic signal including the wireless power signal, the wireless power receiver 3000 may be operated in a wireless power transmission mode.

The MST payment information may include credit card information or payment element corresponding to the credit card by the MST module 3050 included in the wireless power receiver 3000. The wireless power signal may include a control signal and a power signal for wireless power transmission between the wireless power transmitter and receiver that have been described with reference to FIGS. 1 and 16 to 23.

The antenna for combined use 3010 may transmit and receive a magnetic signal to and from an MST reader (not shown). The MST reader may be included in a payment terminal. The payment terminal may include, for example, a POS (or CAT) system and may manage sale information through the POS system. The payment terminal may be generally operated by a casher.

The payment terminal may receive a magnetic signal generated from the antenna for combined use 3010, may decode the magnetic signal, may reconvert the decoded magnetic signal into a digital signal, and may transmit the digital signal to a CPU of the payment terminal.

Needless to say, the antenna for combined use 3010 may receive a wireless power signal from a wireless power transmitter.

According to the present disclosure, the antenna for combined use 3010 is not limited to a wireless power transmission method. In other words, the antenna for combined use 3010 may receive power using at least one of an electromagnetic induction method, an electromagnetic resonance method, a radio frequency (RF) wireless power transmission method, or other wireless power transmission methods.

The antenna for combined use 3010a ccording to the present disclosure is not limited to various wireless power transmission standards that apply the same wireless power transmission method. In other words, the wireless power antenna that receives power using the electromagnetic induction method may receive power according to at least one standard of wireless power consortium (WPC) and/or power matters alliance (PMA). The wireless power antenna that receives power using the electromagnetic resonance method may receive power using a resonance method defined in the alliance for the wireless power (A4WP) standard organization.

The antenna for combined use 3010 may include an inductor and the inductor may include a loop having at least one winding. The inductor of the antenna for combined use 3010 may be wound clockwise or counterclockwise to configure a coil with a polygonal shape such as a circular, oval, or square shape.

A range of inductance of an inductor, required by the MST module 3050, and a range of an inductor, required by the wireless charging module 3070, may overlap each other.

The antenna for combined use 3010 according to the present disclosure may have an inductance value within the range in which the ranges of the inductances of the inductors, required by the MST module 3050 and the wireless charging module 3070, overlap each other. For example, the range of the inductance, required by the MST module 3050 and the wireless charging module 3070, may each be 10 to 13 uH.

In other words, the antenna for combined use 3010 according to the present disclosure may have an inductance value within a range in which the ranges of the inductances, required by the MST module 3050 and the wireless charging module 3070, correspond to each other.

The determination unit 3020 may identify whether the magnetic signal received from the antenna for combined use 3010 is MST payment information or a wireless power signal.

Although the inductance values required by the MST module 3050 and the wireless charging module 3070 are the same, the magnetic signals respectively required by the MST module 3050 and the wireless charging module 3070 may have difference frequency characteristics.

In other words, the magnetic signals for operations of the magnetic security transmission (MST) mode and the wireless power transmission mode may have different frequency characteristics.

The determination unit 3020 may compute the frequency characteristic of the received magnetic signal and may compare the frequency characteristics of the magnetic signals that correspond to the MST module 3050 and the wireless charging module 3070, respectively.

The determination unit 3020 may compare the frequency characteristic of a magnetic signal corresponding to each of the MST module 3050 and the wireless charging module 3070 and frequency characteristic information pre-stored in an internal or external memory of the determination unit 3020. The frequency characteristic information may include a used frequency band, a bandwidth, a frequency magnitude, a frequency phase, or the like.

The determination unit 3020 may determine a module to which the magnetic signal is transferred among the MST module 3050 and the wireless charging module 3070, through the comparison procedure.

The magnetic signal received by the determination unit 3020 may be a ping signal or a beacon signal of a wireless power signal applicable to the WPC standard. When the received magnetic signal is appropriate for the frequency characteristic of the ping signal or the beacon signal, the determination unit 3020 may determine that the received magnetic signal is a signal required for an operation of the wireless charging module 3070.

The switching unit 3030 may transfer the received magnetic signal to any one of the first signal processing unit 3040 that is operatively associated with the MST module 3050 or the second signal processing unit 3060 that is operatively associated with the wireless charging module 3070 according to the determination of the determination unit 3020.

Each of the first signal processing unit 3040 and the second signal processing unit 3060 may re-convert the magnetic signal according to a predefined data frame to enable the MST module 3050 and the wireless charging module 3070 to process the magnetic signal.

For example, the second signal processing unit 3060 that is operatively associated with the wireless charging module 3070 may process a signal based on ASK/FSK.

The MST module 3050 may control and manage an overall MST operation (hereinafter, referred to as the “MST” mode) in which noncontact payment is performed. The MST module 3050 may control a process of generating a magnetic field corresponding to information on a credit card or a payment element corresponding to the credit card.

The wireless charging module 3070 may manage an overall operation (hereinafter, referred to as the “wireless power transmission mode”) for transmitting and receiving a wireless power signal.

A rectifying unit (not shown) may convert current or voltage received from the determination unit into a voltage determined according to each antenna mode.

According to the present disclosure, a device such as a rectifying unit may also be shared along with use of the antenna for combined use 3010 and, thus, material costs may be reduced and duplicated use of devices may be prevented, thereby realizing miniaturization of the wireless power receiver.

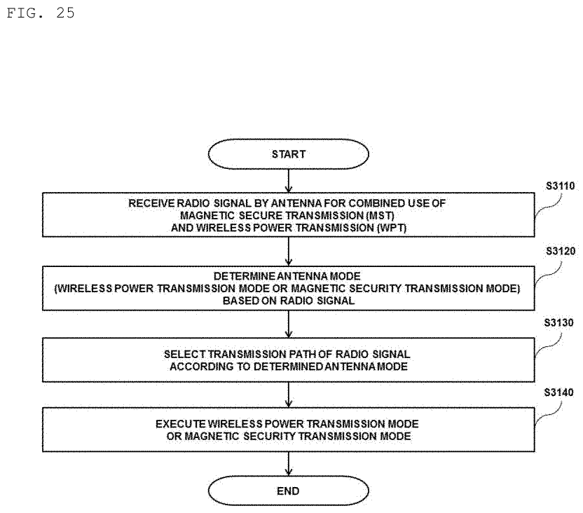

FIG. 25 is a flowchart for explanation of a method of controlling a wireless power receiver including an antenna for combined use of magnetic security transmission (MST) and wireless power transmission (WPT) according to an embodiment.

Referring to FIG. 25, the antenna for combined use of magnetic security transmission (MST) and wireless power transmission (WPT) (hereinafter, referred to as the “the antenna for combined use”) may receive a radio signal (S3110).

The radio signal received from the antenna for combined use may be a magnetic signal generated by the antenna for combined use. The magnetic signal received by the antenna for combined use may include any one of MST payment information and a wireless power signal.

The wireless power receiver may include a short-distance communication antenna (a near field communication (NFC) antenna) along with the antenna for combined use, and may be operated in any one of an MST mode for performing MST payment, a wireless power transmission mode for wirelessly receiving power, and an NFC mode for performing NFC.

The wireless power receiver may determine an antenna mode (a wireless power transmission mode or a magnetic security transmission mode) based on the radio signal (S3120).

The radio signal may include any one of the MST payment information and the wireless power signal but, one radio signal may not simultaneously include the MST payment information and the wireless power signal.

Accordingly, the wireless power receiver may determine an antenna mode based on a radio signal received by the antenna for combined use.

The antenna mode of the wireless power receiver may include an MST mode, a wireless power transmission mode, and an NFC mode. However, the wireless power receiver may not be simultaneously operated in two or more of the MST mode, the wireless power transmission mode, and the NFC mode and may be operated only in any one thereof.

The MST mode may be a mode in which payment information is transmitted and is received to and from an MST reader through an MST antenna, the wireless power transmission mode may be a mode in which power is received using a power signal received from a wireless power transmitter, and the NFC mode may be a mode in which NFC communication is performed.

When receiving a radio signal from the antenna for combined use, the wireless power receiver may determine a mode in which the wireless power receiver is operated.

The wireless power receiver may determine an antenna mode using the magnitude of voltage or current generated by the antenna for combined use according to the radio signal.

The wireless power receiver may determine an antenna mode as the MST mode when the magnitude of voltage or current generated by the antenna for combined use is included in a preset first threshold range, the wireless power receiver may determine the antenna mode as the wireless power transmission mode when the magnitude of voltage or current generated by the antenna for combined use is included in a preset second threshold range.

The first threshold range may be set by an experiment that is related to the magnitude of voltage or current to be generated by a separate MST antenna or may be set according to standard. The second threshold range may be set by an experiment that is related to the magnitude of voltage or current to be generated by a separate wireless power transmission antenna or may be set according to standard.

Alternatively, the wireless power receiver may determine the antenna mode using variation of voltage or current generated by the antenna for combined use a similar method to the above method.

The wireless power receiver may determine the antenna mode using a period or frequency of the radio signal.

A radio signal including a wireless power signal and a radio signal including MST payment information may be transmitted and received according to respective standard or communication protocols.

Accordingly, when the frequency or frequency of the radio signal is analyzed and corresponds to the MST standard, the wireless power receiver may be operated in the MST mode and, when the frequency or frequency of the radio signal corresponds to the wireless power transmission standard, the wireless power receiver may be operated in the wireless power transmission mode.

According to an embodiment, a radio signal received to determine the antenna mode may be a ping signal. In other words, when a frequency or frequency of a ping signal received from the antenna for combined use is analyzed and corresponds to the WPC standard, the wireless power receiver may be operated in the power transmission mode.

The wireless power receiver may select a transmission path of the radio signal according to the determined antenna mode (S3130).

Even if the wireless power receiver uses the antenna for combined use, the wireless power receiver may separately include an MST module and a wireless power transmission module (a wireless charging module) which respectively control the overall MST mode and the overall wireless power transmission mode.

Accordingly, when the antenna mode is the MST mode, the wireless power receiver may select a path in which the radio signal is transmitted to the MST and, when the antenna mode is the wireless power transmission mode, the wireless power receiver may select a path in which the radio signal is transmitted to a wireless charging module.

The wireless power receiver may separately execute the wireless power transmission mode or the magnetic security transmission mode (S3140).

The wireless power receiver may transmit and receive the MST payment information to and from the MST reader according to the MST mode and may charge an internal or external battery with power according to the wireless charging mode.

Prior to this, the antenna for combined use may receive a radio signal using different modulation and demodulation methods according to the MST mode and the wireless power transmission mode, respectively. Accordingly, the wireless power receiver may perform signal processing procedures with different signals when executing the MST mode and the wireless power transmission mode.

The first signal processing unit that is operatively associated with the MST module may perform signal processing according to the MST standard to generate a first control signal and, the second signal processor that is operatively associated with the wireless charging module may perform signal processing according to the wireless power transmission standard to generate a second control signal.

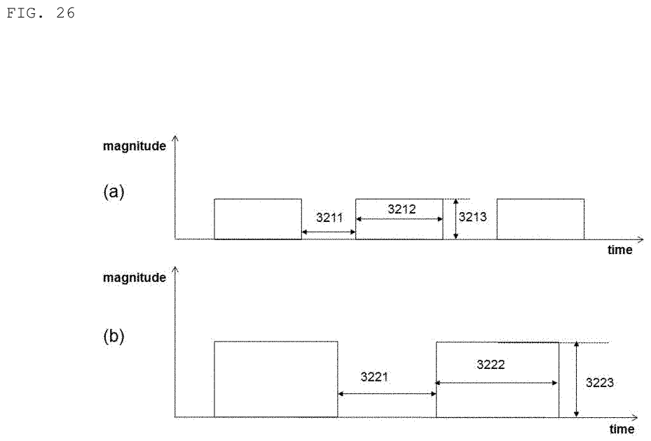

FIG. 26 is a diagram for explanation of an operation of identifying a wireless communication signal received from an antenna for combined use of magnetic security transmission (MST) and wireless power transmission (WPT) according to an embodiment.

Referring to FIG. 26, a wireless power receiver may compute a magnetic signal received from an antenna for combined use of magnetic security transmission (MST) and wireless power transmission (WPT) (hereinafter, the antenna for combined use) and may determine an antenna module using the characteristic of the received magnetic signal.

Depending on the cases, the antenna for combined use may transmit and receive a magnetic signal but, the magnetic signal may include only any one of MST payment information and a wireless power signal.

FIG. 26A is a frequency graph of a first magnetic signal including MST payment information. The x axis has a time as a parameter and the y axis has magnitude or phase of a magnetic signal as a parameter.

The first magnetic signal may be generated from the antenna for combined use and, for example, the first magnetic signal may have a bandwidth corresponding to a pulse timing of 10 to 60 μs in relation to an interval 3211 between signals.

A length 3212 of the first magnetic signal itself may be preset as a byte number including various pieces of information based on a data frame structure and a magnitude 3213 of the first magnetic signal may also have a preset magnitude.

FIG. 26B is a frequency graph of a second magnetic signal including a wireless power signal. The x axis has a time as a parameter and the y axis has magnitude or phase of a magnetic signal as a parameter.

The second magnetic signal may be received as a ping signal or a beacon signal using various types of wireless power transmission methods.

For example, the second magnetic signal of the electromagnetic induction method may be a ping signal and, an interval 3221 between ping signals, a length 3222 of a signal, and a magnitude 3223 of the signal may be preset. Even if the same electromagnetic induction method is used, the characteristics of the signal may be differently set according to different standards (e.g., WPC and PMA). An operation frequency band of an electromagnetic induction method may be an LF band and may be varied to several hundreds of KHz according to standard. The electromagnetic induction method according to the WPC standard may use a frequency band of 110 to 205 KHz, and the electromagnetic induction method using the PMA standard may use a frequency band of 232 to 278 KHz or 205 to 300 KHz.

As another example, a second magnetic signal using an electromagnetic resonance method may be a beacon signal and, an interval 3221 between beacon signals, a length 3222 of a signal, and a magnitude 3223 of the signal may be preset. An operation frequency of the electromagnetic resonance method may be a HF band and may be 6.78 MHz or 13.56 MHz.

The wireless power receiver may compute the characteristic of a magnetic signal received from the antenna for combined use and may compare the computed characteristic of the signal with the characteristic of the first magnetic signal or the characteristic of the second magnetic signal to determine an antenna mode.

The wireless power receiver may also determine an antenna mode using a magnitude of voltage or current generated from the antenna for combined use.

When the magnitude of voltage or current generated by the antenna for combined use according to the magnetic signal received by the antenna for combined use is included in the first threshold range, the wireless power receiver may determine the antenna mode based on the first magnetic signal including the MST payment information.

When the magnitude of voltage or current generated by the antenna for combined use according to the magnetic signal received by the antenna for combined use is included in the second threshold range, the wireless power receiver may determine the antenna mode based on the second magnetic signal including the wireless power signal.

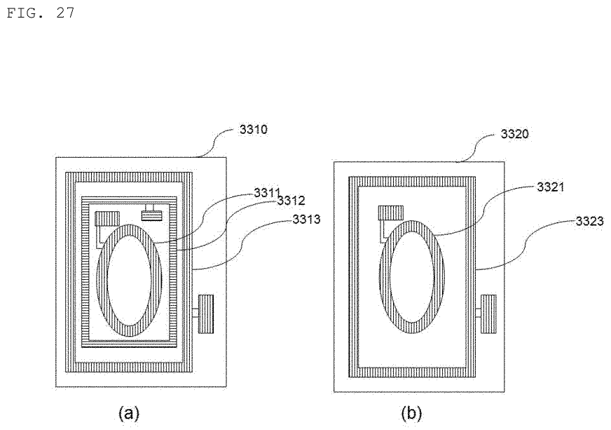

FIG. 27 is a diagram for explanation of antenna arrangement based on use of an antenna for combined use of magnetic security transmission (MST) and wireless power transmission (WPT) according to an embodiment.

Referring to FIG. 27A, a first wireless power receiver 3310 may include all of a wireless power antenna 3311, an MST antenna 3312, and an NFC antenna 3313. The wireless power receiver may execute three modes.

According to an embodiment, the NFC antenna 3313 may use a higher frequency band than the wireless power antenna 3311 and, thus, may be arranged in a conductive pattern in a rectangular shape along the outside of the wireless power antenna 3311. The wireless power antenna 3311 may transmit power and may use a lower frequency band than the NFC antenna 3313 and, thus, may be arranged inside the NFC antenna 3313. In addition, the MST antenna may be disposed in a region between the NFC antenna 3313 and the wireless power antenna 3311.

Referring to FIG. 27B, a second wireless power receiver 3320 according to an embodiment may include an antenna for combined use of magnetic security transmission (MST) and wireless power transmission (WPT) 3321 (hereinafter, referred to as the “antenna for combined use”) and an NFC antenna 3323.

The second wireless power receiver 3320 may include the antenna for combined use 3321 to relatively reduce an arrangement space for antennas compared with the first wireless power receiver 3310. According to the feature of reducing the arrangement space for antennas, an arrangement distance between the antenna for combined use 3321 and the NFC antenna 3323 may be increased and signal interference between antennas may be reduced along with the increase in the arrangement distance. According to the feature of reducing interference in the present disclosure, interference between signals in a magnetic field region may affect each other in a frequency band corresponding to a multiple of an integer and, accordingly, an issue in terms of degradation may be overcome.

In addition, three antennas included in the first wireless power receiver 3310 may require an antenna terminal for transferring a signal generated from each antenna. On the other hand, the second wireless power receiver 3320 may share the required antenna terminals (an MST antenna terminal and a wireless power terminal) and, thus, a space occupied by antenna terminals may be reduced. The reduced space may facilitate miniaturization of the wireless power receiver and, thus, other circuit devices may use the space.

Other than antenna terminals, the second wireless power receiver 3320 may use the antenna for combined use 3321 and, thus, the number of devices to be shared may be increased. For example, a rectifier or a converter that is connected directly to the antenna for combined use 3321 may be shared and used in an MST mode or a wireless power transmission mode.

The method according to the aforementioned embodiment may be prepared in a program to be executable in a computer and may be stored in a computer readable recording medium. Examples of the computer readable recording medium include read-only memory (ROM), random-access memory (RAM), CD-ROMs, magnetic tapes, floppy disks, optical data storage devices, etc. and may be realized in the form of a carrier wave (for example, transmission over the Internet).

The computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

Those skilled in the art will appreciate that the disclosure may be carried out in other specific ways than those set forth herein without departing from the spirit and essential characteristics of the disclosure.

It will be apparent to those skilled in the art that various modifications and variations can be made in the disclosure without departing from the spirit or scope of the disclosure. Thus, it is intended that the disclosure cover the modifications and variations of the embodiment provided they come within the scope of the appended claims and their equivalents.

### INDUSTRIAL APPLICABILITY

The present disclosure may be applicable to a multi-mode antenna for wireless charging and a wireless power reception device using the same.

1. A multi-mode antenna module comprising:
a printed circuit board;
a first antenna that is pattern-printed and disposed in a central region of the printed circuit board for wireless charging;
a second antenna that is pattern-printed and disposed outside the first antenna for first short-distance wireless communication;
a third antenna that is pattern-printed and disposed outside the second antenna not to overlap the second antenna for second short-distance wireless communication;
a first connection terminal for connection of opposite ends of a first connection pattern corresponding to the first antenna; and
a second connection terminal for connection of opposite ends of second and third connection patterns corresponding to the second antenna and the third antenna, respectively,
wherein the first connection terminal and the second connection terminal are separately disposed on the printed circuit board.

2. The multi-mode antenna module of claim 1, wherein the first connection terminal and the second connection terminal are separately disposed on the printed circuit board in such a way that the first connection pattern does not overlap the second antenna and the third antenna.

3. The multi-mode antenna module of claim 1, wherein the first short-distance wireless communication is magnetic secure transmission (MST) and the second short-distance wireless communication is near field communication (NFC).

4. The multi-mode antenna module of claim 1, wherein a separation distance between the second antenna and the third antenna is a minimum of 1 millimeter (mm) or greater.

5. The multi-mode antenna module of claim 4, wherein the second antenna and the third antenna are disposed on the printed circuit board to maintain a deviation of the separation distance between the second antenna and the third antenna to a predetermined reference value or less.

6. The multi-mode antenna module of claim 1, wherein the first antenna and the second antenna are disposed on the printed circuit board to maintain a deviation of a separation distance between the first antenna and the second antenna to a predetermined reference value or less.

7. The multi-mode antenna module of claim 1, wherein the first antenna is pattern-printed on each of opposite surfaces of the printed circuit board, and patterns printed on the opposite surfaces are connected to each other through a penetration hole disposed in the printed circuit board.

8. The multi-mode antenna module of claim 1, wherein the first antenna is printed in a circular pattern with an inner diameter, and the first connection terminal is disposed in the inner diameter.

9. A multi-mode antenna module comprising:
a printed circuit board;
a first antenna that is pattern-printed and disposed in a central region of the printed circuit board for wireless charging;
a second antenna that is pattern-printed and disposed outside the first antenna for first short-distance wireless communication;
a third antenna that is pattern-printed and disposed outside the second antenna not to overlap the second antenna for second short-distance wireless communication;
a first connection terminal for connection of opposite ends of a first connection pattern corresponding to the first antenna; and
a second connection terminal for connection of opposite ends of second and third connection patterns corresponding to the second antenna and the third antenna, respectively,
wherein the first connection terminal and the second connection terminal are separately disposed on the printed circuit board, and the third antenna includes a slit disposed in a length direction of a coil of the third antenna.
